(19) United States
(12) Patent Application Publication
(10) Pub. No.: US 2023/0031779 A1
(43) Pub. Date: Feb. 2, 2023

(54) THERMOPLASTIC BAGS WITH DRAWTAPES HAVING RIBBED DEFORMATION PATTERNS FOR REDUCED FRICTION AND METHODS OF MAKING THE SAME

(71) Applicant: THE GLAD PRODUCTS COMPANY, Oakland, CA (US)

(72) Inventors: Edward B. Tucker, Yorkville, IL (US); Zeljko Vidovic, Mount Prospect, IL (US)

(21) Appl. No.: 17/810,569

(22) Filed: Jul. 1, 2022

Related U.S. Application Data
(60) Provisional application No. 63/203,564, filed on Jul. 27, 2021.

(51) Int. Cl. B65D 33/28

(52) U.S. Cl. CPC B65D 33/28

(57) ABSTRACT

The present disclosure relates to thermoplastic bags having a drawtape within a hem, where the drawtape includes a deformation pattern of a plurality of ribs and a plurality of web areas. The plurality of ribs can include ribs that extend across the drawtape in a non-parallel direction with respect to the width of the drawtape (e.g., at an angle). In some instances, the non-parallel direction causes each rib to point towards a hem hole of the hem that exposes a portion of the drawtape. The plurality of ribs can further be mirrored across an axis that corresponds to a length of the drawtape. In some cases, the ribs are formed via a structural elastic-like film (SELF) process, such as a phased SELF process that leaves a portion of the drawtape without ribs.

### CROSS-REFERENCE TO RELATED APPLICATIONS

This application claims priority to U.S. Provisional Application No. 63/203,564, entitled “THERMOPLASTIC BAGS WITH DRAWTAPES HAVING RIBBED DEFORMATION PATTERNS FOR REDUCED FRICTION AND METHODS OF MAKING THE SAME,” filed Jul. 27, 2021, the entire contents of which are incorporated herein by reference.

### BACKGROUND

Thermoplastic films are a common component in various commercial and consumer bags. For example, grocery bags, trash bags, drawtapes for bags, sacks, and packaging materials are commonly made from thermoplastic films. Such bags often include one or more features that improve the quality and/or functioning of the bag. For example, many bags include a hem formed and a drawtape within the hem. The drawtape enables a user to secure the contents of the bag by pulling the drawtape partially out of the hem to cinch the bag closed.

In some cases, drawtapes of bags are refined via a deformation process that modifies a property of the drawtape, such as its tensile strength, tear resistance, impact resistance, or elasticity. For example, a drawtape can be deformed to provide or improve upon elasticity so that the drawtape can more easily be stretched around the rim of a bin in which the bag is placed and to further enable the bag to grip the rim of the bin once placed inside. These deformation processes often create a plurality of ribs in the drawtape. To illustrate, a structural elastic-like film (SELF) process can deform a drawtape to include a plurality of raised rib-like elements that provide or improve upon the elasticity of the drawtape.

While raised rib-like elements can improve elasticity of a drawtape, they also have some drawbacks. For example, a ribbed drawtape can mechanically engage with the thermoplastic film of the hem as the drawtape moves within the hem. This mechanical engagement leads to a greater amount of force required to pull the drawtape. In instances in which the hem has multiple layers of thermoplastic film, the mechanical engagement with the inner layer of thermoplastic film can cause the inner layer to invert independently from the outer layer of thermoplastic film and bunch at the hem hole, thus requiring even greater force to cinch the drawtape.

In order to increase elasticity along the length of the drawtape, the plurality of raised rib-like elements are oriented to extend across the width of the drawtape (e.g., in a straight line from the top of the drawtape to the bottom of the drawtape in a direction perpendicular to the length of the drawtape). Thus, the plurality of raised rib-like elements lead to increased engagement with the thermoplastic film of the hem as the drawtape moves within the hem. In some instances, the engagement with the thermoplastic film of the hem (and the force required to pull the drawtape out of the hem) increases with the degree to which the raised rib-like elements protrude from the planar face of the drawtape. Other issues often associated with drawtapes include twisting of the drawtape within the hem and tracking of the drawtape during formation of the bag.

Accordingly, there are a number of considerations to be made with regards to drawtape bags and the interaction of a drawtape with its corresponding hem.

### SUMMARY

One or more embodiments of the present disclosure provide benefits and/or solve one or more of the foregoing or other problems in the art with thermoplastic bags having drawtapes that include deformation patterns resulting in reduced mechanical engagement as the drawtape moves within the hem portion of the bag. In particular, in one or more embodiments, a thermoplastic bag includes a drawtape having a plurality of ribs and a plurality of web areas that are out of plane with the ribs. For example, the plurality of ribs can include raised rib-like elements that provide or increase an elasticity of the drawtape. In some instances, the ribs are mirrored across an axis that corresponds to (e.g., runs along) the length of the drawtape. In some cases, each rib extends across the drawtape in a non-parallel direction with respect to the width of the drawtape. Accordingly, the deformation pattern formed by the plurality of ribs reduces the mechanical engagement between the drawtape and the hem portion, thereby, reducing the force required to pull the drawtape at least partially out of the hem portion.

One or more embodiments include a thermoplastic bag comprising a layer of thermoplastic material, a hem portion formed from the layer of thermoplastic material along an edge of the layer of thermoplastic material, and a drawtape within the hem portion. The drawtape includes a plurality of ribs that are mirrored across an axis running along a length of the drawtape. The drawtape further includes a plurality of web areas, the plurality of web areas separating and connecting ribs of the plurality of ribs, wherein the plurality of web areas is out of plane with the ribs of the plurality of ribs so as to create recesses between adjacent ribs of the plurality of ribs.

One or more further embodiments include a thermoplastic bag comprising a first sidewall and a second sidewall opposite the first sidewall. The first and second sidewalls are joined along a first side edge, an opposite second side edge, and a bottom edge. The thermoplastic bag also includes a hem portion along a top of at least one of the first sidewall or the second sidewall and a drawtape within the hem portion. The drawtape includes a plurality of ribs, wherein a rib length associated with each rib extends across the drawtape in a non-parallel direction with respect to a width of the drawtape. The drawtape further includes a plurality of web areas, the plurality of web areas separating and connecting ribs of the plurality of ribs, wherein the plurality of web areas is out of plane with the ribs of the plurality of ribs so as to create recesses between adjacent ribs of the plurality of ribs.

Additionally, one or more embodiments include a method of manufacturing thermoplastic bags having low-friction, elastic drawtapes. The method involves advancing a drawtape through a pair of intermeshing rollers to generate: a plurality of ribs that are mirrored across an axis corresponding to a length of the drawtape, wherein a rib length associated with each rib extends across the drawtape in a non-parallel direction with respect to a width of the drawtape; and a plurality of web areas, the plurality of web areas separating and connecting ribs of the plurality of ribs, wherein the plurality of web areas is out of plane with the ribs of the plurality of ribs so as to create recesses between adjacent ribs of the plurality of ribs. The method further includes inserting the drawtape into a hem portion of a thermoplastic film. Further, the method includes forming the thermoplastic film into a bag.

Additional features and advantages of exemplary implementations of the present invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims or may be learned by the practice of such exemplary embodiments as set forth hereinafter.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates is a perspective view of a thermoplastic bag having a drawtape that includes a deformation pattern of ribs that increase elasticity while reducing friction in accordance with one or more embodiments;

FIG. 2 illustrates a side cross-sectional view of a single-layer thermoplastic bag having a drawtape that includes a deformation pattern of ribs that increase elasticity while reducing friction in accordance with one or more embodiments;

FIG. 3 illustrates a side cross-sectional view of a double-layer thermoplastic bag having a drawtape that includes a deformation pattern of ribs that increase elasticity while reducing friction in accordance with one or more embodiments;

FIG. 4 illustrates a hem portion of a thermoplastic bag and a drawtape having a deformation pattern of ribs that increase elasticity while reducing friction in accordance with one or more embodiments;

FIG. 5 illustrates another hem portion of a thermoplastic bag and a drawtape having a deformation pattern of ribs that increase elasticity while reducing friction in accordance with one or more embodiments;

FIG. 6 illustrates yet another hem portion of a thermoplastic bag and a drawtape having a deformation pattern of ribs that increase elasticity while reducing friction in accordance with one or more embodiments;

FIG. 7 illustrates yet another hem portion of a thermoplastic bag and a drawtape having a deformation pattern of ribs that increase elasticity while reducing friction in accordance with one or more embodiments;

FIG. 8 illustrates another hem portion of a thermoplastic bag and a drawtape having a deformation pattern of ribs that increase elasticity while reducing friction in accordance with one or more embodiments;

FIG. 9 illustrates yet another hem portion of a thermoplastic bag and a drawtape having a deformation pattern of ribs that increase elasticity while reducing friction in accordance with one or more embodiments;

FIGS. 10A-10B each illustrate a pair of SELF'ing intermeshing rollers for creating strainable networks via deformation patterns of ribs that increase elasticity while reducing friction on a drawtape in accordance with one or more embodiments;

FIG. 11 illustrates a pair of SELF'ing intermeshing rollers for creating phased deformations on a drawtape in accordance with one or more embodiments;

FIG. 12 illustrates a portion of a drawtape with deformations of raised rib-like elements in accordance with one or more embodiments;

FIGS. 13A-13D each illustrate a thermoplastic bag having a hem portion that includes a deformation pattern that further reduce friction in accordance with one or more embodiments; and

FIG. 14 illustrates a schematic diagram of a manufacturing process for producing thermoplastic bags having drawtapes that include deformation patterns of ribs that increase elasticity while reducing friction in accordance with one or more embodiments.

### DETAILED DESCRIPTION

One or more embodiments of the present disclosure include a thermoplastic bag having a low-friction drawtape within a hem portion of the thermoplastic bag. In particular, in one or more embodiments, a thermoplastic bag includes a drawtape that has been deformed to include a pattern of ribs that increases elasticity and reduces the mechanical interactions between the drawtape and the hem portion of the thermoplastic bag (and the resulting friction) as a user pulls the drawtape. For example, the ribs can extend across the drawtape in a direction that is non-parallel with respect to the width of the drawtape. In other words, the ribs can extend across the drawtape in a direction other than in a straight line from the top of the drawtape to the bottom of the drawtape. In some instances, the pattern of ribs is symmetrical about an axis runs along, or is parallel to, a length of the drawtape. Further, in some embodiments, the ribs include raised rib-like elements that protrude from the planar surface of the drawtape and increase the elasticity of the drawtape.

As mentioned, in one or more embodiments, the drawtape includes a plurality of ribs. Further, the drawtape can include a plurality of web areas. For example, in some implementations, the plurality of web areas separates and connects ribs of the plurality of ribs. Further, the plurality of web areas is out of plane with the ribs so as to create recesses between adjacent ribs. To illustrate, in some embodiments, the ribs extend outward from the plurality of web areas so that the ribs form raised areas of thermoplastic film and the recesses created by the plurality of web areas form relatively lower areas of thermoplastic film.

In one or more embodiments, the plurality of ribs and the plurality of web areas are formed using a deformation process. For example, the ribs can include raised rib-like elements formed using a structural elastic-like film (SELF) process. In other instances, the plurality of ribs and the plurality of web areas are formed using a ring rolling or an embossing process. In some cases, the plurality of ribs and the plurality of web areas are formed using a phased deformation process.

As further mentioned, in some embodiments, the ribs can extend across the drawtape in a non-parallel direction with respect to the width of the drawtape. In particular, the width of the drawtape can include the distance between the top edge of the drawtape and the bottom edge of the drawtape. Accordingly, the ribs can extend across the drawtape in a direction other than a straight line between the top edge and the bottom edge, which is parallel to the width of the drawtape. As an example, the ribs can extend across the drawtape at an angle that is between being parallel with the width of the drawtape and being perpendicular to the width of the drawtape. In one or more embodiments, the non-parallel direction causes the ribs to point towards a hole in the hem portion (e.g., a hem hole) that exposes the drawtape.

Additionally, as mentioned, in some instances, the ribs are further mirrored across an axis that extends along a length of the drawtape. For example, in some cases, each rib includes a first component on a first side of the axis that extends from the axis across the drawtape in a non-parallel direction with respect to the width of the drawtape and a second component on a second side of the axis that connects to the first component at the axis and mirrors the non-parallel direction of the first component. In other words, each rib is symmetrical about the axis corresponding to the length of the drawtape. In some cases, each rib is positioned entirely on one side of the axis and corresponds to another rib positioned entirely on the other side of the axis. In other words, while the pattern of ribs is symmetrical about the axis corresponding to the length of the drawtape, the ribs themselves may not be.

In one or more embodiments, the pattern of ribs includes a pattern of non-linear components, such as a pattern of chasing arrows, chasing crescents, chasing parabolas, chasing hyperbolas, or a combination of these. In some embodiments, the pattern of ribs includes a pattern of linear components (e.g., straight lines). In some cases, the pattern of ribs includes a pattern comprising a combination of linear components and non-linear components.

Further, in some instances, the plurality of ribs can include ribs of varying rib heights. For example, in some cases, the plurality of ribs includes a first set of ribs having a first rib height and a second set of ribs having a second rib height. In some cases, one or more of the ribs from the plurality of ribs varies in height. For example, a rib can include a height that decreases from the center of the rib to the edge of the rib.

As illustrated by the foregoing discussion, the present disclosure utilizes a variety of terms to describe feature and benefits of one or more embodiments. Additional detail is now provided regarding the meaning of these terms. As used herein, the term “hem portion” (or “hem”) refers to a portion of a thermoplastic bag that houses a drawtape. For example, a hem portion can include an enclosed channel that houses the drawtape. In some cases, a hem portion is formed using the same thermoplastic material used to form a sidewall of the thermoplastic bag. The hem portion of a thermoplastic bag can extend side-to-side between, but does not include, opposing side seals (or tape seals) of the thermoplastic bag.

In some cases, a hem portion of a thermoplastic bag includes a hem hole. As used herein, the term “hem hole” refers to an aperture in the hem. In particular, a hem hole can refer to an opening in the hem portion of a thermoplastic bag that exposes a portion of the drawtape housed within the hem. Accordingly, the drawtape can be pulled at least partially out through the hem hole to close the thermoplastic bag. In some cases, as will be illustrated below, a thermoplastic bag includes multiple hem portions, each having a hem hole that exposes respective portions of the drawstring.

As indicated above, a drawstring can include a pattern of deformations. As used herein, the term “deformation” (or “deformations”) refers to one or more structures permanently formed in a thermoplastic film and/or a drawtape. For example, deformations can comprise alternating thicker ribs and thinner webs formed from ring rolling, raised rib-like elements and their corresponding web areas formed from SELF'ing, or displaced designs formed by embossing. Relatedly, as used herein, the term “deformation pattern” refers to a series of repeating deformations. For example, a deformation pattern can refer to a plurality of ribs (e.g., raised rib-like elements) and a plurality of web areas that repeat (e.g., in shape, direction, rib height, etc.) across the surface upon which the deformation pattern exists.

More particularly, a deformation pattern can include a pattern of ribs and a pattern of web areas that connect to form an overall pattern. Indeed, as used herein, the term “pattern of ribs” refers to a series of repeating ribs. In particular, the ribs can include a shape and/or orientation that is repeated throughout the series. To illustrate, a pattern of ribs can include a pattern of non-linear components, such as a pattern of chasing arrows, a pattern of chasing crescents, a pattern of chasing parabolas, a pattern of chasing hyperbolas, or a pattern consisting of some combination of arrows, crescents, parabolas, and/or hyperbolas. In some cases, a pattern of ribs includes a pattern of linear components, such as a pattern of lines. In some implementations, a pattern of ribs includes a combination of linear and non-linear components. As used herein, the term “pattern of web areas” refers to a series of repeating web areas. In particular, a pattern of web areas can form the recesses between adjacent ribs in a pattern of ribs.

As used herein, the term “rib height” refers to a degree of protrusion from a planar surface. For example, a rib height can refer to a degree to which a rib extends from a planar surface formed by a web area—the web area forming a recess between adjacent ribs. A rib height can vary across a single rib. For example, a rib height can decrease from a center of a rib to the edge of the rib or vice versa. In some cases, a rib height can vary among a set of ribs where each rib has a consistent rib height from center-to-edge but has a different rib height than other ribs in the set.

Additionally, as used herein, the term “elasticity” refers to a quality of a thermoplastic material and/or drawtape that is associated with stretchiness. In particular, elasticity can refer to the ability of a thermoplastic material and/or drawtape to resume its normal shape after being stretched or compressed. In some cases, the elasticity of a thermoplastic bag and its drawstring allow the thermoplastic bag and drawstring to more easily be fitted over the rim of a bin or receptable in which the thermoplastic bag is placed.

In some cases, a thermoplastic film—used to form a thermoplastic bag—includes multiple layers of thermoplastic material. As used herein, the terms “lamination,” “laminate,” and “laminated film,” refer to the process and resulting product made by bonding together two or more layers of a film or other material. The term “bonding,” when used in reference to bonding of multiple layers of a multi-layer film, may be used interchangeably with “lamination” of the layers. According to methods of the present disclosure, adjacent layers of a multi-layer film are laminated or bonded to one another. The bonding purposely results in a relatively weak bond between the layers that has a bond strength that is less than the strength of the weakest layer of the film. This allows the lamination bonds to fail before the film layer, and thus the bond, fails.

The term laminate is also inclusive of coextruded multi-layer films comprising one or more tie layers. As a verb, “laminate” means to affix or adhere (by means of, for example, adhesive bonding, pressure bonding, ultrasonic bonding, corona lamination, and the like) two or more separately made film articles to one another so as to form a multi-layer structure. As a noun, “laminate” means a product produced by the affixing or adhering just described.

As used herein the terms “partially discontinuous bonding” or “partially discontinuous lamination” refers to lamination of two or more layers where the lamination is substantially continuous in the machine direction or in the transverse direction, but not continuous in the other of the machine direction or the transverse direction. Alternately, partially discontinuous lamination refers to lamination of two or more layers where the lamination is substantially continuous in the width of the article but not continuous in the height of the article, or substantially continuous in the height of the article but not continuous in the width of the article. More particularly, partially discontinuous lamination refers to lamination of two or more layers with repeating bonded patterns broken up by repeating unbounded areas in either the machine direction or the transverse direction or both. Both partially discontinuous and discontinuous are types of non-continuous bonding (i.e., bonding that is not complete and continuous between two surfaces).

In addition to non-continuous bonding, one or more implementations include incrementally stretching a thermoplastic film. For example, one or more implementations includes incrementally stretching a thermoplastic film using MD ring rolling, TD ring rolling, DD ring rolling, the formation of strainable networks, or combinations thereof. Incrementally stretching a thermoplastic film using the methods described herein can impart ribs or other structures to the film and increase or otherwise modify one or more of the tensile strength, tear resistance, impact resistance, or elasticity of the film. Furthermore, one or more embodiments involve stretching processes with ambient or cold (non-heated) conditions. This differs significantly from most conventional processes that stretch films under heated conditions. Stretching under ambient or cold conditions in accordance with one or more implementations can constrain the molecules in the thermoplastic film so they are not as easily oriented as under heated conditions. Such cold incremental stretching can help provide the unexpected result of maintaining or increasing the strength of a thermoplastic film, despite a reduction in gauge.

Relatively weak bonding and stretching can be accomplished simultaneously through one or more suitable techniques. For example, bonding and stretching may be achieved by pressure (for example MD ring rolling, TD ring rolling, helical or DD ring rolling, stainable network lamination or SELFing, or embossing), or with a combination of heat and pressure. Alternately, a manufacturer can first stretch the films and then bond the films using one or more bonding techniques. For example, one or more implementations can include ultrasonic bonding to lightly laminate the films. Alternately or additionally, adhesives can laminate the films. Treatment with a Corona discharge can enhance any of the above methods. In one or more embodiments, the contacting surfaces/layers can comprise a tacky material to facilitate lamination. Prior to lamination, the separate films can be film or can be subject to separate processes, such as stretching, slitting, coating and printing, and corona treatment.

As used herein, the term “substantially,” in reference to a given parameter, property, or condition, means to a degree that one of ordinary skill in the art would understand that the given parameter, property, or condition is met within a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “flexible” refers to materials that are capable of being flexed or bent, especially repeatedly, such that they are pliant and yieldable in response to externally applied forces. Accordingly, “flexible” is substantially opposite in meaning to the terms inflexible, rigid, or unyielding. Materials and structures that are flexible, therefore, may be altered in shape and structure to accommodate external forces and to conform to the shape of objects brought into contact with them without losing their integrity. In accordance with further prior art materials, web materials are provided which exhibit an “elastic-like” behavior in the direction of applied strain without the use of added traditional elastic. As used herein, the term “elastic-like” describes the behavior of web materials which when subjected to an applied strain, the web materials extend in the direction of applied strain, and when the applied strain is released the web materials return, to a degree, to their pre-strained condition.

As used herein, any relational terms such as “first,” “second,” and “third,” “inner,” “outer,” “upper,” “lower,” “side,” “top,” “bottom,” etc. are for clarity and convenience in understanding the present disclosure and accompanying drawings and does not connote or depend on any specific preference, orientation, or order, except where the context clearly indicates otherwise. For example, the relational terms may refer an orientation of a multi-layer bag while disposed within a receptacle (e.g., a trash can) for use. Film Materials

As an initial matter, the thermoplastic material of the films of one or more implementations (e.g., used to form the thermoplastic bags or drawtape) can include, but are not limited to, thermoplastic polyolefins, including polyethylene and copolymers thereof and polypropylene and copolymers thereof. The olefin-based polymers can include the most common ethylene or propylene-based polymers such as polyethylene, polypropylene, and copolymers such as ethylene vinylacetate (EVA), ethylene methyl acrylate (EMA) and ethylene acrylic acid (EAA), or blends of such polyolefins.

Other examples of polymers suitable for use as films in accordance with the present disclosure may include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), oriented poly(ethylene-terephthalate), poly(ethylene-butylacrylate), polyurethane, poly(ethylene-propylene-diene), ethylene-propylene rubber, nylon, etc.

Some of the examples and description herein below refer to films formed from linear low-density polyethylene. The term “linear low-density polyethylene” (LLDPE) as used herein is defined to mean a copolymer of ethylene and a minor amount of an olefin containing 4 to 10 carbon atoms, having a density of from about 0.910 to about 0.926, and a melt index (MI) of from about 0.5 to about 10. For example, some examples herein use an octene comonomer, solution phase LLDPE (MI=1.1; p=0.920). Additionally, other examples use a gas phase LLDPE, which is a hexene gas phase LLDPE formulated with slip/AB (MI=1.0; p=0.920). Still further examples use a gas phase LLDPE, which is a hexene gas phase LLDPE formulated with slip/AB (MI=1.0; p=0.926). One will appreciate that the present disclosure is not limited to LLDPE, and can include “high density polyethylene” (HDPE), “low density polyethylene” (LDPE), and “very low-density polyethylene” (VLDPE). Indeed, films made from any of the previously mentioned thermoplastic materials or combinations thereof can be suitable for use with the present disclosure.

Some embodiments of the present disclosure may include any flexible or pliable thermoplastic material that may be formed or drawn into a web or film. Furthermore, each thermoplastic film may include a single layer or multiple layers of thermoplastic materials. The thermoplastic material may be opaque, transparent, translucent, or tinted. Furthermore, the thermoplastic material may be gas permeable or impermeable.

For example, films of the thermoplastic films described herein may include a single film formed from one, two, three, or more layers of thermoplastic material. In some implementations, the film may include a single layer film, comprising a single layer. In other implementations, the film can comprise a two-layer film, including a first layer and a second layer. The first and second layers can be coextruded. In such implementations, the first and second layers may optionally include different grades of thermoplastic material and/or include different additives, including polymer additives. In yet other implementations, the film be a tri-layer film, including a first layer, a second layer, and a third layer. In yet other implementations, a film may include more than three layers. The tri-layer film can include an A:B:C configuration in which all three layers vary in one or more of gauge, composition, color, transparency, or other properties. Alternatively, the tri-layer film can comprise an A:A:B structure or A:B:A structure in which two layers have the same composition, color, transparency, or other properties. In an A:A:B structure or A:B:A structure the A layers can comprise the same gauge or differing gauge. For example, in an A:A:B structure or A:B:A structure the film layers can comprise layer ratios of 20:20:60, 40:40:20, 15:70:15, 33:34:33, 20:60:20, 40:20:40, or other ratios.

Additional additives that may be included in one or more embodiments include slip agents, anti-block agents, voiding agents, or tackifiers. Additionally, one or more implementations of the present disclosure include films that are devoid of voiding agents. Some examples of inorganic voiding agents, which may further provide odor control, include the following but are not limited to: calcium carbonate, magnesium carbonate, barium carbonate, calcium sulfate, magnesium sulfate, barium sulfate, calcium oxide, magnesium oxide, titanium oxide, zinc oxide, aluminum hydroxide, magnesium hydroxide, talc, clay, silica, alumina, mica, glass powder, starch, charcoal, zeolites, any combination thereof, etc. Organic voiding agents, polymers that are immiscible in the major polymer matrix, can also be used. For instance, polystyrene can be used as a voiding agent in polyethylene and polypropylene films.

Further additives that may be included in one or more embodiments include natural oils. For example, the additives may include thyme oil, mint oil, lemon grass oil, tea tree oil, cinnamon bark oil, methyl jasmonate, etc. Yet further additives may include zinc pyrithione (“ZPT”) and copper pyrithione (“CPT”), which inhibit microbial growth.

One of ordinary skill in the art will appreciate in view of the present disclosure that manufacturers may form the films or webs to be used with the present disclosure using a wide variety of techniques. For example, a manufacturer can form a precursor mix of the thermoplastic material and one or more additives. The manufacturer can then form the film(s) from the precursor mix using conventional flat or cast extrusion or coextrusion to produce monolayer, bilayer, or multilayer films. Alternatively, a manufacturer can form the films using suitable processes, such as, a blown film process to produce monolayer, bilayer, or multilayer films. If desired for a given end use, the manufacturer can orient the films by trapped bubble, tenterframe, or other suitable process. Additionally, the manufacturer can optionally anneal the films thereafter.

An optional part of the film-making process is a procedure known as “orientation.” The orientation of a polymer is a reference to its molecular organization, i.e., the orientation of molecules relative to each other. Similarly, the process of orientation is the process by which directionality (orientation) is imposed upon the polymeric arrangements in the film. The process of orientation is employed to impart desirable properties to films, including making cast films tougher (higher tensile properties). Depending on whether the film is made by casting as a flat film or by blowing as a tubular film, the orientation process can require different procedures. This is related to the different physical characteristics possessed by films made by the two conventional film-making processes; casting and blowing. Generally, blown films tend to have greater stiffness and toughness. By contrast, cast films usually have the advantages of greater film clarity and uniformity of thickness and flatness, generally permitting use of a wider range of polymers and producing a higher quality film.

When a film has been stretched in a single direction (monoaxial orientation), the resulting film can exhibit strength and stiffness along the direction of stretch, but can be weak in the other direction (i.e., across the stretch), often splitting when flexed or pulled. To overcome this limitation, two-way or biaxial orientation can be employed to more evenly distribute the strength qualities of the film in two directions. Most biaxial orientation processes use apparatus that stretches the film sequentially, first in one direction and then in the other.

In one or more implementations, the films of the present disclosure are blown film, or cast film. Blown film and cast film is formed by extrusion. The extruder used can be a conventional one using a die, which will provide the desired gauge. Some useful extruders are described in U.S. Pat. Nos. 4,814,135; 4,857,600; 5,076,988; 5,153,382; each of which are incorporated herein by reference in their entirety. Examples of various extruders, which can be used in producing the films to be used with the present disclosure, can be a single screw type modified with a blown film die, an air ring, and continuous take off equipment.

In one or more embodiments, a manufacturer can use multiple extruders to supply different melt streams, which a feed block can order into different channels of a multi-channel die. The multiple extruders can allow a manufacturer to form a multi-layer film with layers having different compositions. Such multi-layer film may later be non-continuously laminated with another layer of film.

In a blown film process, the die can be an upright cylinder with a circular opening. Rollers can pull molten plastic upward away from the die. An air-ring can cool the film as the film travels upwards. An air outlet can force compressed air into the center of the extruded circular profile, creating a bubble. The air can expand the extruded circular cross section by a multiple of the die diameter. This ratio is called the “blow-up ratio.” When using a blown film process, the manufacturer can collapse the film to double the plies of the film. Alternatively, the manufacturer can cut and fold the film, or cut and leave the film unfolded.

In any event, in one or more embodiments, the extrusion process can orient the polymer chains of the blown film. In particular, the extrusion process can cause the polymer chains of the blown film to be predominantly oriented in the machine direction. The orientation of the polymer chains can result in an increased strength in the direction of the orientation. As used herein predominately oriented in a particular direction means that the polymer chains are more oriented in the particular direction than another direction. One will appreciate, however, that a film that is predominately oriented in a particular direction can still include polymer chains oriented in directions other than the particular direction. Thus, in one or more embodiments the initial or starting films (films before being stretched or bonded or laminated in accordance with the principles described herein) can comprise a blown film that is predominately oriented in the machine direction.

The process of blowing up the tubular stock or bubble can further orient the polymer chains of the blown film. In particular, the blow-up process can cause the polymer chains of the blown film to be bi-axially oriented. Despite being bi-axially oriented, in one or more embodiments the polymer chains of the blown film are predominantly oriented in the machine direction (i.e., oriented more in the machine direction than the transverse direction).

The films of one or more implementations of the present disclosure can have a starting gauge between about 0.1 mils to about 20 mils, suitably from about 0.2 mils to about 4 mils, suitably in the range of about 0.3 mils to about 2 mils, suitably from about 0.6 mils to about 1.25 mils, suitably from about 0.9 mils to about 1.1 mils, suitably from about 0.3 mils to about 0.7 mils, and suitably from about 0.4 mils and about 0.6 mils. Additionally, the starting gauge of films of one or more implementations of the present disclosure may not be uniform. Thus, the starting gauge of films of one or more implementations of the present disclosure may vary along the length and/or width of the film.

As an initial matter, one or more layers of the films described herein can comprise any flexible or pliable material comprising a thermoplastic material and that can be formed or drawn into a web or film. As described above, the film includes a plurality of layers of thermoplastic films. Each individual film layer may itself include a single layer or multiple layers. In other words, the individual layers of the multi-layer film may each themselves comprise a plurality of laminated layers. Such layers may be significantly more tightly bonded together than the bonding provided by the purposely weak discontinuous bonding in the finished multi-layer film. Both tight and relatively weak lamination can be accomplished by joining layers by mechanical pressure, joining layers with adhesives, joining with heat and pressure, spread coating, extrusion coating, and combinations thereof. Adjacent sub-layers of an individual layer may be coextruded. Coextrusion results in tight bonding so that the bond strength is greater than the tear resistance of the resulting laminate (i.e., rather than allowing adjacent layers to be peeled apart through breakage of the lamination bonds, the film will tear).

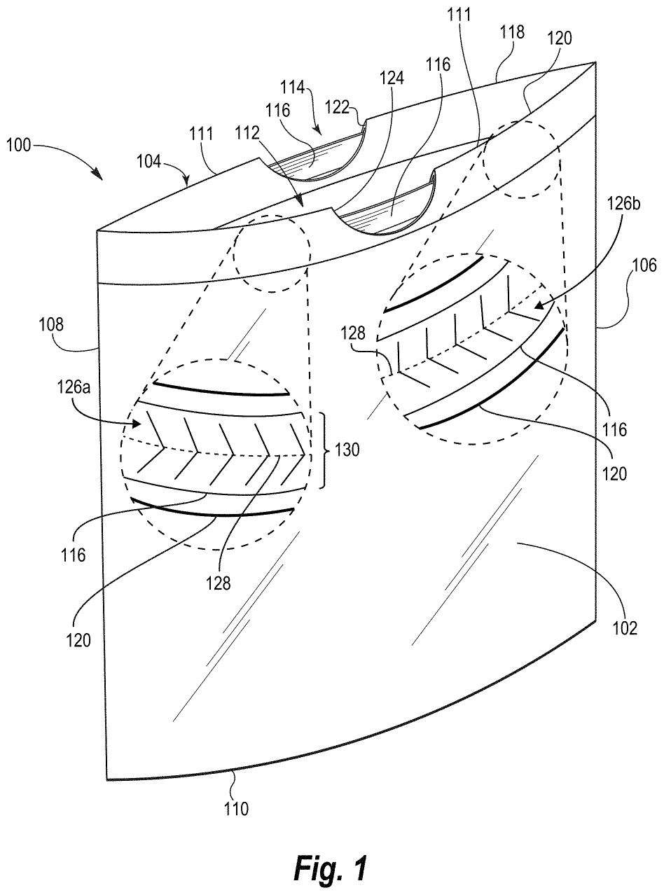

Referring now to the figures, FIG. 1 is a perspective view of a thermoplastic bag 100 according to an embodiment of the present disclosure. The thermoplastic bag 100 includes a first sidewall 102 and a second sidewall 104. Each of the first and second sidewalls 102, 104 includes a first side edge 106, a second opposite side edge 108, a bottom edge 110 extending between the first and second side edges 106, 108, and a top edge 111 extending between the first and second side edges 106, 108 opposite the bottom edge 110. In some embodiments, the first sidewall 102 and the second sidewall 104 are joined together along the first side edges 106, the second side edges 108, and the bottom edges 110. The first and second sidewalls 102, 104 may be joined along the first and second side edges 106, 108 and bottom edges 110 by any suitable process such as, for example, a heat seal.

In some embodiments, the bottom edge 110 or one or more of the first and second side edges 106, 108 can comprise a fold. In other words, the first and second sidewalls 102, 104 may comprise a single unitary piece of material. The top edges 111 of the first and second sidewalls 102, 104 may define an opening 112 to an interior of the thermoplastic bag 100. In other words, the opening 112 may be oriented opposite the bottom edge 110 of the thermoplastic bag 100. Furthermore, when placed in a trash receptacle, the top edges 111 of the first and second sidewalls 102, 104 may be folded over the rim of the receptacle.

In some embodiments, the thermoplastic bag 100 may optionally include a closure mechanism 114 located adjacent to the top edges 111 for at least partially closing the top of the thermoplastic bag 100 to form an at least substantially fully-enclosed container or vessel. As shown in FIG. 1, in some embodiments, the closure mechanism 114 comprises a drawtape 116, a first hem 120, and a second hem 118. In particular, the first top edge 111 of the first sidewall 102 may be folded back into the interior volume and may be attached to an interior surface of the first sidewall 102 to form the first hem 120. Similarly, the second top edge 111 of the second sidewall 104 is folded back into the interior volume and may be attached to an interior surface of the second sidewall 104 to form a second hem 118. The drawtape 116 extends through the first and second hems 120, 118 along the first and second top edges 111. The first hem 120 includes a first aperture 124 (e.g., a first hem hole) extending through the first hem 120 and exposing a portion of the drawtape 116. Similarly, the second hem 118 includes a second aperture 122 (e.g., a second hem hole) extending through the second hem 118 and exposing another portion of the drawtape 116. During use, pulling the drawtape 116 through the first and second apertures 124, 122 will cause the first and second top edges 111 to constrict. As a result, pulling the drawtape 116 through the first and second apertures 124, 122 will cause the opening 112 of the thermoplastic bag 100 to at least partially close or reduce in size. The drawtape closure mechanism 114 may be used with any of the implementations of a thermoplastic bag described herein.

As further shown in FIG. 1, the drawtape 116 includes a plurality of ribs and a plurality of web areas in deformation patterns 126a -126b. Indeed, as shown, the deformation patterns 126a -126b include ribs that are mirrored across an axis 128 that corresponds to (e.g., is parallel to) a length of the drawtape 116. In particular, each rib in the deformation patterns 126a -126b is symmetrical about the axis 128 corresponding to the length of the drawtape 116.

Further, as shown, the deformation patterns 126a -126b include ribs that extend across the drawtape 116 in a non-parallel direction with respect to the width 130 of the drawtape 116. In particular, the deformation patterns 126a -126b include ribs that extend across the drawtape at an angle that is between being parallel to the width of the drawtape 116 and being perpendicular to the width of the drawtape 116. Though FIG. 1 illustrates the deformation patterns 126a -126b including a particular pattern of ribs (e.g., a pattern of chasing arrows), the deformation patterns 126a -126b can include various alternative or additional patterns of ribs.

Additionally, as shown in FIG. 1, the deformation patterns 126a -126b do not extend to portions of the drawtape 116 that are exposed by the first and second apertures 124, 122. But it should be noted that the deformation patterns 126a -126b can extend into those exposed portions of the drawtape 116 in some implementations. Further, as shown, the ribs of the deformation patterns 126a -126b point to the portions of the drawtape 116 that are exposed in apertures 122, 124 in this particular embodiment.

By including the deformation patterns 126a -126b, the drawtape 116 reduces the mechanical engagement with the first and second hems 120, 118 as the drawtape 116 moves within the first and second hems 120, 118. For example, as the drawtape 116 is pulled out of the first and second hems 120, 118 through the first and second apertures 124, 122, respectively, the deformation patterns 126a -126b create reduced friction when compared to other drawtapes. Accordingly, the thermoplastic bag 100 requires less force to pull the drawtape 116 out through the first and second apertures 124, 122 to close the thermoplastic bag 100. Further, by including the deformation patterns 126a -126b, the drawtape 116 is less likely to twist within the first and second hems 120, 118. Indeed, the deformation patterns 126a -126b tend to cause the drawtape 116 to lay flat within the first and second hems 120, 118. Furthermore, the deformation patterns 12a-126b can reduce the surface area of the drawtape 116 that comes into contact with the inner surfaces of the hems 120, 118. More specifically, as the ribs of the deformation patterns are raised, in one or more embodiments, the ribs are the substantially the only portions of the drawtape 116 that contact the inner surface of the hems 120, 118. More detail regarding deformation patterns and the ribs and web areas making up such deformation patterns will be discussed below.

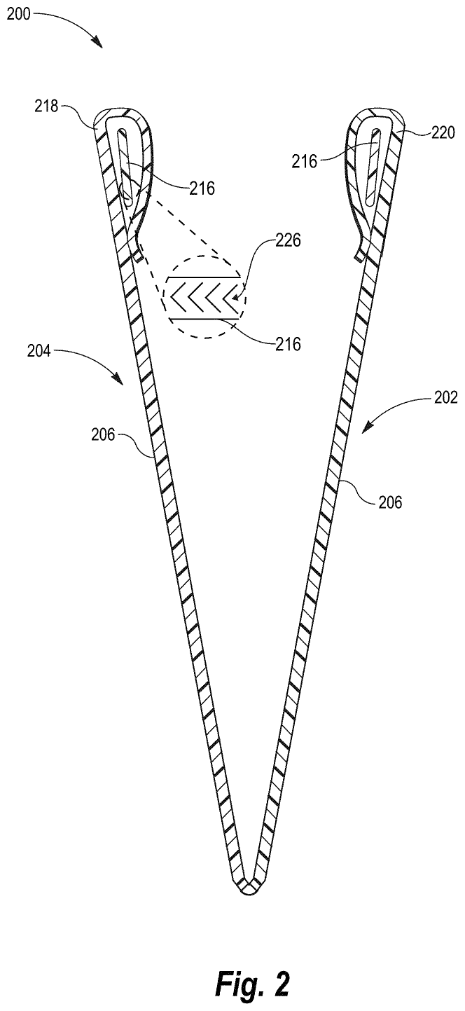

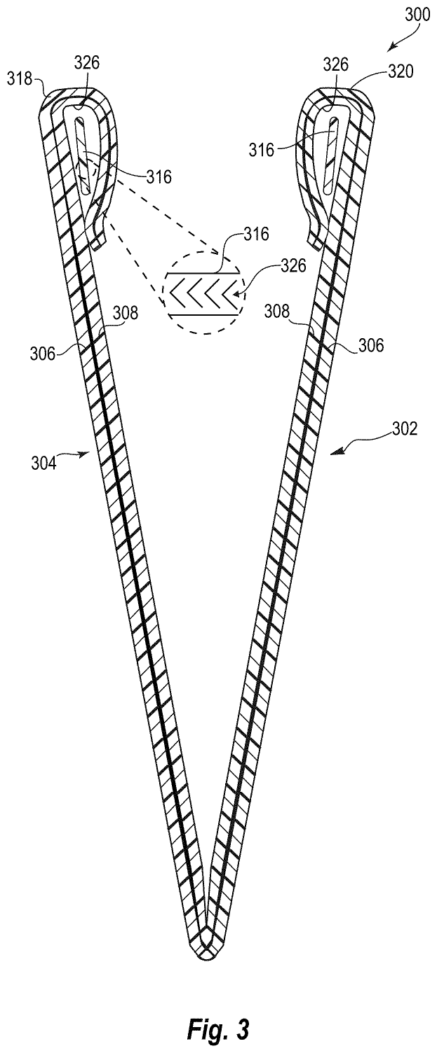

FIG. 2 illustrates a side cross-sectional view of a thermoplastic bag 200 having a low-friction, elastic drawtape according to an embodiment of the present disclosure. As shown in FIG. 2, each of the first sidewall 202 and the second sidewall 204 of the thermoplastic bag 200 includes a single layer of thermoplastic film 206. The thermoplastic film 206 of the first sidewall 202 and the second sidewall 204 can include any of the thermoplastic films described above. In one or more embodiments, each of the first and second sidewalls 202, 204 of the thermoplastic bag 200 includes multiple layers of thermoplastic film as will be discussed below with reference to FIG. 3.

Further, as shown, the thermoplastic bag 200 includes a first hem 220 and a second hem 218. As shown, the first hem 220 is formed from the thermoplastic film 206 of the first sidewall 202, and the second hem 218 is formed from the thermoplastic film 206 of the second sidewall 204. Thus, the first and second hems 220, 218 include the single layer of the thermoplastic film 206. In some instances, however, the first hem 220 and/or the second hem 218 can include additional layers of the thermoplastic film 206 or additional layers formed from other thermoplastic films, such as those described above.

Additionally, as shown in FIG. 2, the thermoplastic bag 200 includes a drawtape 216 within the first and second hems 220, 218. In particular, the drawtape 216 includes a plurality of ribs and a plurality of web areas in deformation patterns (as shown by the deformation pattern 226). As illustrated, the deformation patterns include patterns of chasing arrows that point to a hem hole associated with the first and second hems 220, 218 (where the hem holes are positioned in the page, behind the cross-section illustrated.

In some cases, a thermoplastic bag includes multiple layers of thermoplastic film. FIG. 3 is a side cross-sectional view of a thermoplastic bag 300 having a low-friction, elastic drawtape according to an embodiment of the present disclosure. As shown in FIG. 3, each of the first and second sidewalls 302, 304 of the thermoplastic bag 300 includes multiple layers of thermoplastic film. In particular, each of the first and second sidewalls 302, 304 includes a first film 306 and a second film 308. The first and second films 306, 308 may include films such as any of the films described above.

Further, as shown, the thermoplastic bag 300 includes a first hem 320 and a second hem 318. As shown, the first hem 320 is formed from the first film 306 and the second film 308 of the first sidewall 302, and the second hem 318 is formed from the first film 306 and the second film 308 of the second sidewall 304. Thus, the first and second hems 320, 318 include multiple layers of film. Though FIG. 3 illustrates the first and second hems 320, 318 including a specific number of layers of film, the first and second hems 320, 318 can include additional layers of the first film 306 and/or the second film 308 or additional layers formed from other thermoplastic films, such as those described above.

Additionally, as shown in FIG. 3, the thermoplastic bag 300 includes a drawtape 316 within the first and second hems 320, 318. In particular, the drawtape 316 includes a plurality of ribs and a plurality of web areas in deformation patterns (as shown by the deformation pattern 326). As illustrated, the deformation patterns include patterns of chasing arrows that point to a hem hole associated with the first and second hems 320, 318 (where the hem holes are positioned in the page, behind the cross-section illustrated.

By including the deformation patterns illustrated in FIG. 3 (and discussed in more detail below), the drawtape 316 of the thermoplastic bag 300 reduces the mechanical engagement between the drawtape 316 and the inner layer of thermoplastic film within the first and second hems 320, 318 (e.g., the second film 308). Thus, the drawtape 316 can avoid causing the inner layer of thermoplastic film of the first and second hems 320, 318 (e.g., the second film 308) to invert independently from the outer layer of thermoplastic film (e.g., the first film 306) and bunching at the hem hole. Accordingly, the drawtape 316 can reduce the amount of force required to pull the drawtape 316 out of the first and second hems 320, 318.

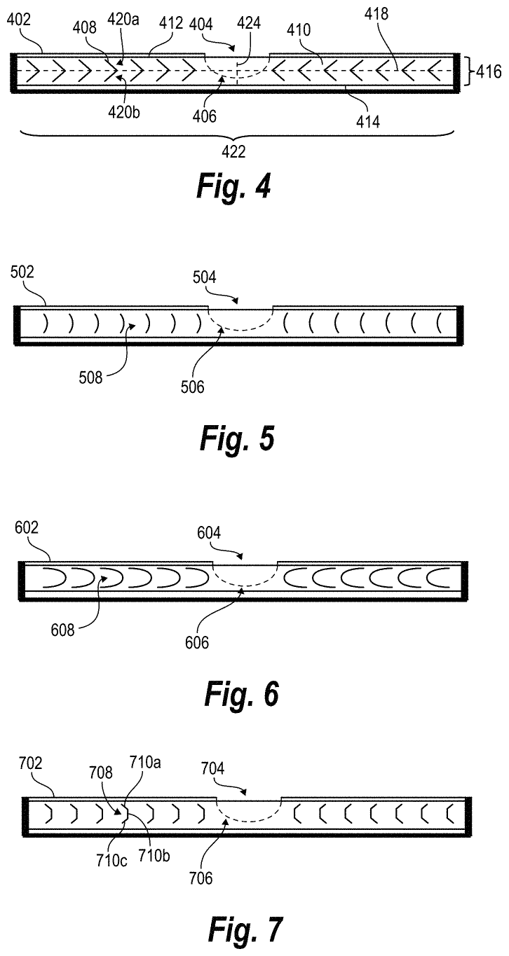

As mentioned above, the drawtape of a thermoplastic bag can include a deformation pattern that decreases the mechanical engagement between the drawtape and the hem of the thermoplastic bag. In particular, the drawtape can include a pattern of ribs and a pattern of web areas that reduces the friction created as the drawtape is pulled at least partially out of the hem of the thermoplastic bag. FIGS. 4-9 each illustrate a drawtape within a hem portion of a thermoplastic bag having a deformation pattern according to an embodiment of the present disclosure.

In particular, FIG. 4 illustrate a hem portion 402 of a thermoplastic bag (not shown) and a drawtape 404 within the hem portion 402 according to an embodiment of the present disclosure. As further shown, the drawtape 404 is exposed by the hem hole 406 of the hem portion 402. The hem hole 406 is configured to enable a user to grab onto the drawtape 404 and pull the drawtape 404 through the hem hole 406 (e.g., at least partially out of the hem portion 402) to close the thermoplastic bag. As illustrated, the drawtape 404 includes a top edge 412 and a bottom edge 414. The width 416 of the drawtape 404 includes a distance between the top edge 412 and the bottom edge 414.

Additionally, as shown in FIG. 4, the drawtape 404 includes a plurality of ribs, such as the rib 408. Further, the drawtape 404 includes a plurality of web areas, such as the web area 410. As shown in FIG. 4, the web areas separate and connect the ribs. Further, the web areas are out of plane with the ribs so as to create recesses between adjacent ribs.

As shown in FIG. 4, the plurality of ribs and the plurality of web areas do not span the width 416 of the drawtape 404. In other words, the deformation pattern that includes the ribs and the web areas extends a distance between the top edge 412 and the bottom edge 414 that is less than the width 416 of the drawtape 404. Indeed, non-deformed drawtape can exist on either edge of the drawtape 404 or on both edges. In some instances, having non-deformed drawtape on both edges of the drawtape 404 creates symmetry and facilitates improved tape tracking during the process of forming thermoplastic bags with the drawtape 404. It should be understood, however, that the plurality of ribs and the plurality of web areas can span the width 416 of the drawtape 404 entirely in some embodiments.

Additionally, as shown in FIG. 4, the plurality of ribs and the plurality of web areas do not extend to the portion of the drawtape 404 exposed by the hem hole 406. In particular, the deformation pattern includes a portion without ribs, the portion without ribs being aligned with the portion of the drawtape 404 exposed by the hem hole 406 (or, said differently, the drawtape 404 includes two deformation patterns that terminate at or just before the portion of the drawtape 404 exposed by the hem hole 406). For example, in one or more embodiments, the plurality of ribs and the plurality of web areas are created on the drawtape 404 via a phased SELF process, which will be discussed in more detail below. It should be noted, however, that the plurality of ribs and the plurality of web areas can extend to the portion of the drawtape 404 exposed by the hem hole 406 in some instances.

As further shown in FIG. 4, the ribs are mirrored across an axis 418 that corresponds to the length 422 of the drawtape 404. For example, the rib 408 includes a first component 420a on a first side (e.g., the top side) of the axis 418 and further includes a second component 420b on a second side (e.g., the bottom side) of the axis 418. The second component 420b connects to the first component 420a at the axis 418 and further mirrors the first component 420a (e.g., mirrors the length, direction, and/or rib height of the first component 420a ).

As illustrated in FIG. 4, the axis 418 is located in the center of the drawtape 404 with respect to the width 416 of the drawtape. In other words, the axis 418 is positioned in the middle with respect to the top edge 412 and the bottom edge 414 of the drawtape. It should be understood, however, that the ribs of the drawtape 404 can be mirrored across an axis located at various positions with respect to the width 416 of the drawtape 404. Further, in some instances, the ribs are mirrored across multiple axes that correspond to the length 422 of the drawtape 404 and are located at various positions with respect to the width 416 of the drawtape 404. In some implementations, the ribs are not mirrored across an axis corresponding to the length of the corresponding drawtape at all. Rather, the ribs are asymmetric with respect to such an axis.

Additionally, rather than each rib including components that mirror one another across the axis 418 corresponding to the length 422 of the drawtape 404, the drawtape 404 can include ribs that are positioned entirely on one side of the axis 418 and have a corresponding “mirrored” rib on the other side of the axis 418. Accordingly, the plurality of ribs of the drawtape 404 are mirrored across the axis 418 corresponding to the length 422 of the drawtape 404 by having a first set of ribs located above the axis 418 and a mirroring set of ribs located below the axis.

Further, as shown in FIG. 4, each rib extends across the drawtape 404 in a non-parallel direction with respect to a width 416 of the drawtape 404. Indeed, each rib (e.g., each component of the rib) extends across the drawtape 404 at an angle between being parallel to the width 416 of the drawtape 404 and being perpendicular to the width 416 of the drawtape 404. In particular, as shown in FIG. 4, the non-parallel direction of each rib causes each rib to point towards the hem hole 406. As the direction of pull placed upon the drawtape 404 (as the drawtape is drawn through the hem hole 406) is substantially parallel to the length 422 of the drawtape 404, each rib extends at least partially in the direction of pull. Conventional drawtapes with rib structures often create a significant amount of mechanical force when extracted from a hem because the length of the rib structures is perpendicular to the length of the drawtape (i.e., perpendicular to the direction of pull) and the ends of the rib structures frictionally snag the hem as the drawtape is pulled. As shown by FIG. 4, the shape/configuration of each rib facilitates the reduction in mechanical engagement between the drawtape 404 and the hem portion 402 as the drawtape 404 is pulled due to the angle between the end portion of the rib and the direction of pull being made increasingly more acute, which allows the hem to deflect way from the rib rather than snag the rib thereby reducing the amount of force required to pull the drawtape 404 out of the hem hole 406.

Additionally, as illustrated in FIG. 4, the plurality of ribs and the plurality of web areas are mirrored across an axis 424 corresponding to a width of the drawtape 404. In particular, the deformation pattern includes a first set of ribs and web areas on one side (e.g., the left side) of the axis 424 and a second set of ribs and web areas that are located on the other side (e.g., the right side) of the axis 424 and mirror the first set of ribs. Indeed, the deformation pattern is symmetrical about the axis 424 (or, said differently, the drawtape 404 includes two deformation patterns that are located on either side of the axis 424 and mirror one another). In particular, as shown the set of ribs on the left side of the hem hole 406 and the set of ribs on the right side of the hem hole 406 mirror each other as all of the ribs point toward the hem hole 406. In some instances, however, a drawtape includes a deformation pattern that is not symmetrical about an axis corresponding to a width of the drawtape. Indeed, in some instances the ribs on one side of such an axis do not mirror the ribs on the other side. Though FIG. 4 particularly illustrated the axis 424 corresponding to the width of the drawtape 404 located at the portion of the drawtape 404 exposed by the hem hole 406, it should be understood that the axis can be located at various other portions of the drawtape 404 in other embodiments.

In one or more embodiments, each rib of the drawtape 404 includes the same rib height. Further, in some cases, each rib includes a consistent rib height where the height of a rib is the same from the center of the rib to the edge of the rib. In some instances, however, rib height can vary across the ribs of a drawtape 404. For example, the rib height can vary across a single rib. To illustrate, in one or more embodiments, the rib height of a rib decreases from the center of the rib to the edge of the rib or vice versa. In some implementations, the rib height is different among various ribs of a drawtape 404. For example, the drawtape 404 can include a first set of ribs having a first rib height and further include a second set of ribs having a second rib height that is different than the first rib height. Indeed, the rib height can vary in many ways across the drawtape.

FIG. 4 illustrates the drawtape 404 having a particular pattern of ribs that includes a pattern of chasing arrows. Thermoplastic bags, however, can includes drawtapes having various other patterns of ribs. In particular, thermoplastic bags can include drawtapes having various other patterns of ribs that include ribs that extend across drawtape in a non-parallel direction with respect to the width of the drawtape and/or are mirrored across an axis corresponding to the length of the drawtape. For example, the drawtape of a thermoplastic bag can include a pattern of ribs that includes a pattern of chasing crescents, a pattern of chasing parabolas, a pattern of chasing hyperbolas, a pattern of some other shape, a pattern of dots, a pattern of dashes, or one of various other patterns. In some cases, the drawtape of a thermoplastic bag includes a deformation pattern that matches or is substantially similar to a deformation pattern formed elsewhere on the thermoplastic bag.

For example, FIG. 5 illustrates a drawtape 504 within a hem portion 502 of a thermoplastic bag (not shown) that includes a pattern of ribs 508 having a pattern of shallow curves (e.g., shallow parabolas) according to an embodiment of the present disclosure. The ribs 508 can provide the drawtape with increased elasticity, thereby, allowing the drawtape 504 to be stretched around a receptable opening.

As shown, each rib 508 points towards the hem hole 506 of the hem portion 502. In particular, each rib 508 curves towards the hem hole 506. Indeed, as shown, the pattern of ribs 508 is part of a deformation pattern that is symmetrical about the hem hole 506. Similar to the deformation pattern of ribs of FIG. 4, the deformation pattern of ribs 508 shown in FIG. 5 are mirrored across an axis extending along a mid-line of the drawtape 504. Thus, the configuration and arrangement of the deformation pattern of ribs 508 help facilitate easy drawing of the drawtape 504 within the hem portion 502. In particular, the ribs 508 can reduce the surface area of the hem portion 502 that contact the drawtape 504. Additionally, the shape and direction that the ribs 508 point facilitate pulling of the drawtape 504 toward and out of the hem hole 506.

Similarly, FIG. 6 illustrates a drawtape 604 within a hem portion 602 of a thermoplastic bag (not shown) that includes a pattern of ribs 608 having a pattern of deep curves (e.g., deep or non-shallow parabolas) according to an embodiment of the present disclosure. As shown, each rib 608 points towards the hem hole 606 of the hem portion 602. In particular, the vertex of each rib 608 is pointing towards the hem hole 606 and each rib 608 curves from its respective vertex away from the hem hole 606. Indeed, as shown, the pattern of ribs is part of a deformation pattern that is symmetrical about the hem hole 606.

Similar to the ribs described above, the ribs 608 can provide the drawtape 604 with increased elasticity while also decreasing the force required to pull the drawtape through the hem portion 602 to cinch a bag. In particular, the height of the ribs 608 compared to the rest of the surface of the drawtape 604 can reduce the area of contact between the drawtape 604 and the hem portion 602. The reduction of area of contact reduces friction between the drawtape 604 and the hem portion 602, thereby, increasing the ease of pulling the drawtape 604 through the hem portion 602. Furthermore, the shape the ribs 608 and pointing direction can help guide the drawtape 604 through the hem portion 602 toward the hem hole 606.

As mentioned above, ribs of one or more implementations are non-parallel to the width of the drawtape into which they are formed. The non-parallel orientation to the width can prevent the ribs from catching the inner surface of the hem and causing bunching of the hem portion as the drawtape is pulled through the hem portion. One will appreciate that one or more implementations can include ribs that are not entirely parallel to the width of the drawtape but nonetheless include portions that are parallel to the width of the drawtape. For example, FIG. 7 illustrates a drawtape 704 within a hem portion 702 of a thermoplastic bag that includes a pattern of ribs 708 that are composed of a series of lines according to an embodiment of the present disclosure. As shown each rib 708 points towards the hem hole 706 of the hem portion 702 as the series of lines open up away from the hem hole 706. Indeed, as shown, the pattern of ribs 708 is part of a deformation pattern that is symmetrical about the hem hole 706.

Particularly, as shown in FIG. 7, the ribs 708 of the drawtape 704 include a component that extends across the drawtape 704 in a parallel direction with respect to a width of the drawtape 704. For example, each rib from the pattern of ribs 708 includes the components 710a -710c. The component 710b extends across the drawtape 704 in a parallel direction with respect to the width of the drawtape 704 while the components 710a, 710c extend across the drawtape 704 in a non-parallel direction with respect to the width of the drawtape 704. Accordingly, the ribs 708 of the drawtape 704 can include a combination of one or more components that extend in a parallel direction and one or more components that extend in a non-parallel direction with respect to the width of the drawtape.

Similar to the ribs described above, the ribs 708 can provide the drawtape 704 with increased elasticity while also increasing the ease of travel of the drawtape 704 through the hem portion 702. In particular, the height of the ribs 708 compared to the rest of the surface of the drawtape 704 can help reduce the web areas of the drawtape from contacting the inner surface of the hem portion 702, thereby, reducing friction between the drawtape 704 and the hem portion 702.

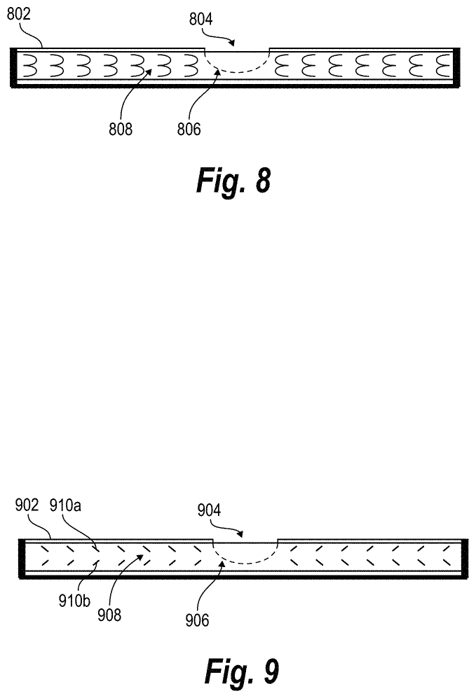

FIG. 8 illustrates a drawtape 804 within a hem portion 802 of a thermoplastic bag that includes a pattern of ribs 808 where each rib forms a w-shape according to an embodiment of the present disclosure. In particular, as shown in FIG. 8, the pattern of ribs 808 extends across the length of the drawtape 804 so that the length of each rib is oriented in a direction that is non-parallel with respect to the width of the drawtape 804. Further, each rib opens in a direction away from the hem hole 806 of the hem portion 802 (i.e., each rib points toward the hem hole 806).

As previously suggested, the non-parallel orientation of the ribs with respect to the width of the drawtape 804 can prevent the edges of the ribs from catching the inner surface of the hem portion 802. Indeed, the non-parallel orientation of the ribs with respect to the width of the drawtape 804 can reduce the mechanical forces typically involved as the drawtape 804 is pulled from the hem portion 802. To provide more detail, conventional drawtapes with rib structures often create a significant amount of mechanical force when extracted from a hem, because the length of the rib structures is perpendicular to the length of the drawtape (i.e., perpendicular to the direction of pull) and the ends of the rib structures frictionally snag the hem as the drawtape is pulled.

By reducing the angle between the end portions of the ribs and the direction of pull, the drawtape 804 can reduce the friction created between the drawtape 804 and the hem portion 802. In particular, as the angle between the ribs and the direction of pull becomes more acute, the ribs enable the hem portion 802 to deflect away the ends of the ribs. Accordingly, the potential for frictional snagging reduces, and the drawtape 804 can be extracted from the hem portion 802 with less pulling force required. Though this has been discussed with particular reference to FIG. 8, the same benefits are provided by those rib patterns discussed with reference to FIGS. 4-7, the rib pattern discussed below with reference to FIG. 9, and similar rib patterns discussed herein.

The ribs included on a drawtape can include various different configurations. FIG. 9 illustrates a drawtape 904 within a hem portion 902 of a thermoplastic bag that includes a pattern of ribs 908 where the ribs do not extend across the center-line of the drawtape 904 according to an embodiment of the present disclosure. For example, the pattern of ribs 908 includes the rib 910a on the top half of the drawtape 904 and the corresponding ribs 910b on the bottom half of the drawtape 904 that mirrors the ribs 910a. As shown, the ribs 910a -910b both are composed of linear elements and are oriented to point toward the hem hole 906.

As shown in FIG. 9, however, the center of the drawtape 904 (e.g., a center-line positioned equal distance from a top edge and a bottom edge of the drawtape) with respect to the length of the drawtape 904 has not been deformed to include ribs (e.g., is devoid of ribs). Indeed, the ribs from the pattern of ribs 908 do not extend into the center of the drawtape 904. Thus, a drawtape can include a configuration that includes a first set of ribs formed on a top half of the drawtape and a second, separate set of ribs formed on the bottom half of the drawtape. The lack of ribs along the center-line of the drawtape 904 can further reduce friction by reducing the surface area of the ribs, while also increasing elasticity and tracking of the drawtape within the hem.

As shown in FIGS. 4-9, a drawtape can include a plurality of ribs composed of non-linear components, such as curves, parabolas, arrows, etc. In some embodiments, though a rib is non-linear in its entirety, the rib can include linear components (e.g., the arrow-shaped ribs of FIG.

4 or the ribs composed of a series of lines discussed with reference to FIG. 7). In some implementations, however, a drawtape can include a plurality of ribs that are linear in their entirety. In some cases, a drawtape can include a plurality of ribs composed of a combination of linear components and non-linear components. For example, a drawtape can include a set of ribs composed of linear components and another set of ribs composed of non-linear components. In some instances, a drawtape includes one or more ribs composed of both linear and non-linear components.

As previously mentioned, in one or more embodiments, the ribs of a drawtape include raised rib-like elements. In particular, the ribs include raised rib-like elements formed through a SELF process (which also forms the web areas). Indeed, in accordance with one implementation, a SELF process may be used to create a drawtape with strainable networks. Indeed, any of the bags mentioned above can include a drawtape created using the SELF process. In some implementations (e.g., where the drawtape includes multiple layers), the SELF process results in discontinuous bonding of adjacent layers. Indeed, the strainable networks can include adjacent bonded and un-bonded regions. U.S. Pat. Nos. 7,942,577; 5,518,801; 6,139,185; 6,150,647; 6,394,651; 6,394,652; 6,513,975; 6,695,476; U.S. Patent Application Publication No. 2004/0134923; and U.S. Patent Application Publication No. 2006/0093766 each disclose processes for forming strainable networks or patterns of strainable networks suitable for use with implementations of the present disclosure. The contents of each of the aforementioned patents and publications are incorporated in their entirety by reference herein. As used herein, the term “strainable network” refers to an interconnected and interrelated group of regions which are able to be extended to some useful degree in a predetermined direction providing the web material with an elastic-like behavior in response to an applied and subsequently released elongation.

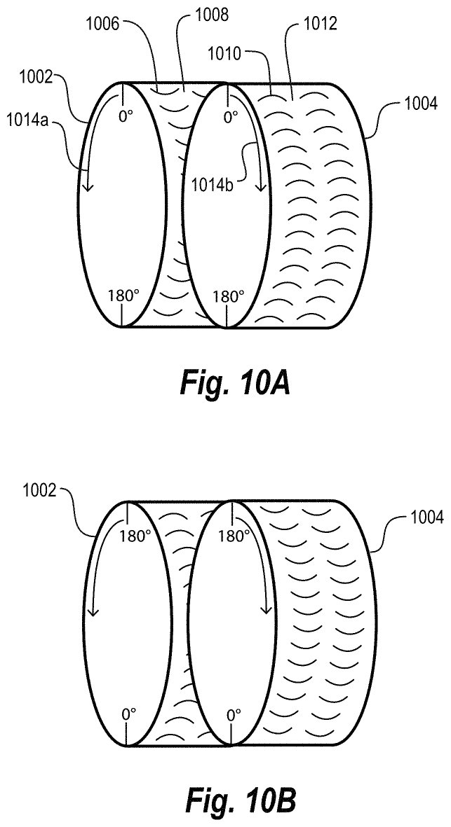

FIG. 10A illustrates a pair of SELF'ing intermeshing rollers 1002, 1004 for creating strainable networks on a pair of drawtapes according to an embodiment of the present disclosure. As shown in FIG. 10A, the first SELF'ing intermeshing roller 1002 can include a plurality of ridges (such as the ridge 1006) and a plurality of grooves/notches (such as the groove/notch 1008) extending generally radially outward in a direction orthogonal to an axis of rotation. As further shown, the second SELF'ing intermeshing roller 1004 can include a corresponding plurality of ridges (such as the ridge 1010) and a corresponding plurality of grooves/notches (such as the groove/notch 1012) extending generally radially outward in a direction orthogonal to an axis of rotation.

In one or more implementations, the plurality of ribs—such as those described above with reference to FIGS. 4-9—are formed on a drawtape by advancing the drawtape between the first and second SELF'ing intermeshing rollers 1002, 1004. For example, as a drawtape is advanced between the first and second SELF'ing intermeshing rollers 1002, 1004, the first and second SELF'ing intermeshing rollers 1002, 1004 rotate in the directions 1014a, 1014b, respectively. The first and second SELF'ing intermeshing rollers 1002, 1004 further engage with the drawtape. Accordingly, the ridges of the first and second SELF'ing intermeshing rollers 1002, 1004 can form raised rib-like elements on the drawtape.

FIG. 10B illustrates the sides of the pair of SELF'ing intermeshing rollers 1002, 1004 not shown in FIG. 10A. Notably, however, the ridges on the opposite sides of the SELF'ing intermeshing rollers 1002, 1004 are oriented in the opposite direction when compared to the ridges of the first and second SELF'ing intermeshing rollers 1002, 1004 shown in FIG. 10A. Thus, a single rotation of the pair of SELF'ing intermeshing rollers 1002, 1004 can create a first deformation pattern of ribs on a first part or half of a drawtape material and a second deformation pattern of ribs on a second part or half of the drawtape material.

Indeed, as suggested above, each roller of a pair of SELF'ing intermeshing rollers can include a first set of ridges oriented in one direction and a second set of ridges oriented in the opposite direction so that a drawtape advanced through the SELF'ing intermeshing rollers would include a first set of raised rib-like elements that point in a first direction and a second set of raised rib-like elements that point in a second direction (e.g., the ribs of the first and second sets of raised rib-like elements point towards a hem hole that exposes a portion of the drawtape).

In some instances, the circular pitch of the ridges of the SELF'ing intermeshing rollers can vary from 40 pitch (0.040 inch) to 200 pitch (0.200 inch). In some instances, the circular pitch varies about the tooling circumference to advantageously provide more elasticity at certain portions of the drawtape. As used herein, the term “pitch” refers to the distance between the tips of two adjacent ridges on the same roller. Another measure, the “depth of engagement” (“DOE”) refers to the amount of overlap between ridges of the different SELF'ing intermeshing rollers during intermeshing. The pitch and depth of engagement of the ridges can determine, at least in part, the amount of incremental stretching and partially discontinuous lamination caused by the phased SELF'ing intermeshing rollers.

As mentioned above, the ribs and web areas of a drawtape can be formed through phased SELF'ing. In some instances, the ribs and web areas are formed via phased ring rolling. In particular, a drawtape can include one or more phased deformation patterns. As used herein, the term “phased deformation pattern” refers to a pattern of deformations that vary from a first side of a drawtape, along a length of the drawtape, to an opposing side of the drawtape. In other words, a phased deformation pattern is a deformation pattern that does not repeat consistently or uniformly across a length of a drawtape. For example, a phased deformation pattern can include a first zone with a first deformation pattern and a second zone with a second deformation pattern, where the first and second zones are aligned, at least partially, along a length of the thermoplastic bag. Alternatively, a first zone can have a deformation pattern that is deeper than a second zone.

To create phased deformation patterns, one or more embodiments include the use of the intermeshing rollers that are sized and configured based on a length of a drawtape. In other words, the intermeshing rollers are phased or registered to correspond to a multiple of a length of the drawtape. The intermeshing rollers have teeth or gears that vary along the circumference of the intermeshing rollers so as to produce a pattern in a drawtape that varies from one side of a drawtape to an opposing side of the drawtape.

By phasing the ring rolling or SELF'ing of a drawtape, one or more implementations provide a drawtape with zones or sections with tailored strength and/or aesthetic characteristics. For example, one or more implementations include reducing or eliminating ring rolling or SELF'ing in areas of the drawtape in which seals are formed. Still further implementations include drawtapes with varying patterns of ring rolling or SELF'ing that create zones or sections with unique performance in the machine direction, transverse direction, or both. For instance, one or more implementations include drawtapes with zones that have differing functional properties (stretch differently or have differing strength or other material properties) or aesthetic properties.

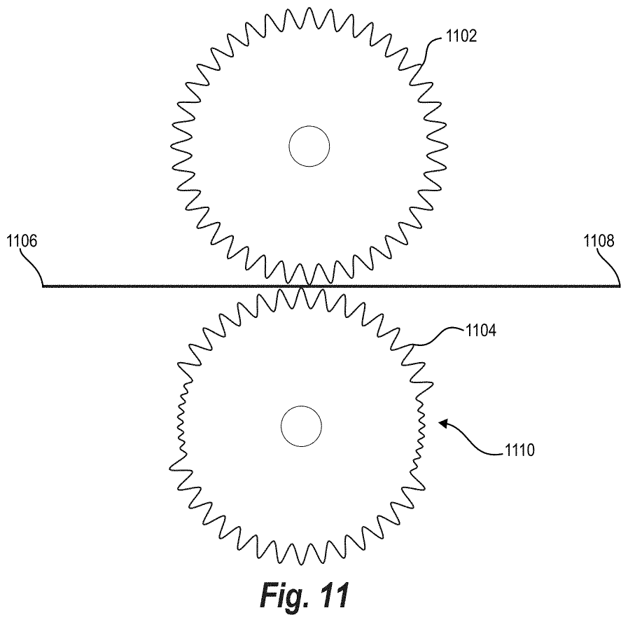

FIG. 11 illustrates a pair of SELF'ing intermeshing rollers 1102, 1104 (e.g., a first SELF'ing intermeshing roller 1102 and a second SELF'ing intermeshing roller 1104) for creating phased deformations according to an embodiment of the present disclosure. In one or more embodiments, to form a drawtape having phased SELF'ing or ring rolling, the tooling is sized and configured such that one revolution (or fraction thereof) equals the length of a drawtape. For example, at least one of the SELF'ing intermeshing rollers 1102, 1104 are sized and configured that one revolution equals the length of a drawtape included in a single thermoplastic bag.

Thus, considering FIG. 11, a method of forming a 1108 drawtape with phased deformations can involve advancing a drawtape 1106 into the pair of SELF'ing intermeshing rollers 1102, 1104. Advancing the drawtape 1106 through the pair of SELF'ing intermeshing rollers 1102, 1104 creates deformations (e.g., the ribs described above) in the drawtape 1106. A single rotation of the SELF'ing intermeshing rollers 1102, 1104 spans a first length of the drawtape material. The drawtapes have a length that is a multiple of the first length. After forming the phased deformation patterns, the method can involve forming pairs of side seals in the drawtape 1108 (e.g., cutting the drawtape 1108 and sealing the edges of the drawtape 1108 to the hem portion of a thermoplastic bag) thereby defining drawtapes having a length that is a multiple of the first length. In the embodiment shown in FIG. 11, the multiple of the first length is 1, such that the length of a drawtape equals, or approximately equals, the circumference of the SELF'ing intermeshing rollers 1102, 1104. In alternative embodiments, the multiple of the first length is 2, 3, 4, 5, or so on.

As further shown by FIG. 11, the SELF'ing intermeshing roller 1104 can further include at least one region 1110 having a different set of ridges and grooves/notches. For example, as shown, the region 1110 includes a set of smaller ridges. In some cases, the region 1110 can be devoid of ridges and grooves/notches and/or include a region with a second set of ridges and grooves/notches in another configuration to form a deformation pattern (e.g., chasing parabolas) other than that formed by the first set of ridges and grooves/notches (e.g., chasing arrows). The region 1110 can extend along a length of the SELF'ing intermeshing roller 1104. As shown by

FIG. 11, the region 1110 can result in no deformations being formed in a zone of the drawtape 1108 with phased deformations. For example, as discussed above, a drawtape can be devoid of ribs at a portion of the drawtape that is exposed by a hem hole of a hem portion within which the drawtape is placed. A drawtape can also be devoid of ribs at a portion of the drawtape used to create a side seal for the thermoplastic bag. Accordingly, in some embodiments, the direction of the ridges alternate at 180 degrees from the region 1110 so that the resulting ribs point at the hem hole in a symmetric manner.

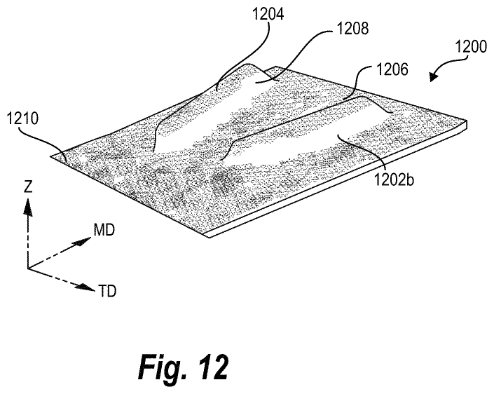

FIG. 12 shows a portion of a drawtape 1200 with the deformations. In some instances, the drawtape 1200 of FIG. 12 represents a drawtape with a pattern created from a SELFing process. Indeed, as a drawtape passes through SELF'ing intermeshing rollers (e.g., the SELF'ing intermeshing rollers 1102, 1104), the teeth can press a portion of the drawtape material (e.g., thermoplastic film) out of the plane defined by the drawtape material to cause permanent deformation of a portion of the drawtape material in the Z-direction. For example, the teeth can intermittently stretch a portion of the drawtape material in the Z-direction. The portions of the drawtape material that pass between the notched regions of the teeth will remain substantially unformed in the Z-direction. As a result of the foregoing, the drawtape 1200 with the phased deformations includes a plurality of isolated deformed, raised rib-like elements 1202b and at least one un-deformed portion (or web area) 1210 (e.g., a relatively flat region). As will be understood by one of ordinary skill in the art, the length and width of the rib-like elements 1202b depend on the length and width of teeth and the speed and the depth of engagement of the SELF'ing intermeshing rollers 1102, 1104. The rib-like elements 1202b and the un-deformed web areas 1210 form a strainable network.

As shown in FIG. 12, the strainable network of the drawtape 1200 can include first thicker regions 1204, second thicker regions 1206, and stretched, thinner transitional regions 1208 connecting the first and second thicker regions 1204, 1206. The first thicker regions 1204 and the stretched, thinner transitional regions 1208 can form the raised rib-like elements 1202b of the strainable network. In one or more embodiments, the first thicker regions 1204 are the portions of the drawtape material with the greatest displacement in the Z-direction. In one or more embodiments, because the drawtape material is displaced in the Z-direction by pushing the rib-like elements 1202b in a direction perpendicular to a main surface of the drawtape (thereby stretching the regions 1208 upward) a total length and width of the drawtape does not substantially change when the film is subjected to the SELF process of one or more embodiments of the present invention. In other words, the drawtape material (prior to undergoing the SELF process) can have substantially the same width and length as the drawtape 1200 resulting from the SELF process.

The edges of the first thicker regions 1204—in other words, where the material transitions from the first thicker regions 1204 to the stretched, thinner transitional regions 1208— can include the edges of the raised rib-like elements 1202b. Indeed, as mentioned above, in one or more embodiments, a drawtape can include a plurality of ribs of varying rib height among across ribs collectively or individually. For raised rib-like elements of individually-varying rib height, the rib height can differ from the center of the raised rib-like element to the edge of the raised rib-like element.

As shown by FIG. 12, the raised rib-like elements can have a major axis and a minor axis (i.e., the raised rib-like elements are elongated such that they are longer than they are wide). As shown by FIG. 12, in one or more embodiments, the major axes of the raised rib-like elements are non-parallel to the machine direction (i.e., the direction in which the drawtape material was extruded). Additionally, the major axes of the raised rib-like elements are non-parallel to the transverse direction. In still further embodiments, the major axes of the raised rib-like elements are oriented at an angle between 1 and 89 degrees relative to the machine direction. For example, in one or more embodiments, the major axes of the raised rib-like elements are at a 45-degree angle to the machine direction. In one or more embodiments, the major axes are linear (i.e., in a straight line) in alternative embodiments the major axes are curved or have otherwise non-linear shapes as discussed above with reference to FIGS. 4-9.

The raised rib-like elements 1202b can undergo a substantially “geometric deformation” prior to a “molecular-level deformation.” As used herein, the term “molecular-level deformation” refers to deformation, which occurs on a molecular level and is not discernible to the normal naked eye. That is, even though one may be able to discern the effect of molecular-level deformation, e.g., elongation or tearing of the film, one is not able to discern the deformation, which allows or causes it to happen. This is in contrast to the term “geometric deformation,” which refers to deformations that are generally discernible to the normal naked eye when a SELF'ed drawtape or articles embodying such a drawtape are subjected to an applied load or force. Types of geometric deformation include, but are not limited to bending, unfolding, and rotating.

Thus, upon application of a force, the raised rib-like elements 1202b can undergo geometric deformation before undergoing molecular-level deformation. For example, a strain applied to the drawtape 1200 in a direction perpendicular to the major axes of the raised rib-like elements 1202b can pull the raised rib-like elements 1202b back into plane with the web areas 1210 prior to any molecular-level deformation of the raised rib-like elements 1202b. Geometric deformation can result in significantly less resistive forces to an applied strain than that exhibited by molecular-level deformation.

In some instances, a drawtape includes raised rib-like elements of varying length. It should be noted, however, that a drawtape can include a deformation pattern where all of the raised rib-like elements are of the same length. Further, it should be noted that the drawtape 1200 includes a particular deformation pattern that facilitates discussion of raised rib-like elements and corresponding web areas. However, a drawtape can include other deformation patterns, such as those discussed above with reference to FIGS. 4-9.

By utilizing a drawtape that includes raised rib-like elements, a thermoplastic bag can more easily be stretched to fit over the rim of a bin, such as a trash receptacle. As the raised rib-like elements improve upon the elasticity of the drawtape, the drawtape can facilitate gripping the rim of the bin once the thermoplastic bag has been placed inside. By using a drawtape with a deformation pattern, such as those described above with reference to FIGS. 4-9, a thermoplastic bag can maintain the stretching/gripping benefits provided by the raised rib-like elements while reducing the frictional forces that they cause. Indeed, the deformation patterns can reduce the mechanical engagement typically caused between the raised rib-like elements and the hem portion of the thermoplastic bag as the drawtape is pull outwards. Thus, the deformation patterns reduce the amount of force required to pull the drawtape at least partially out of the hem portion.

Though FIGS. 10A-12 discuss SELF processes and drawtapes created from one of the discussed SELF processes, it should be noted that the drawtapes described herein can be created from various alternative processes. For example, the drawtapes can be created to include a plurality of ribs and a plurality of web areas using a ring rolling process as described in U.S. patent application Ser. No. 15/967,238, filed Apr. 30, 2018, and entitled “NON-CONTINUOUSLY LAMINATED STRUCTURES OF THERMOPLASTIC FILMS WITH DIFFERING MATERIAL COMPOSITIONS AND FUNCTIONAL MATERIAL PROPERTIES” and issued as U.S. Pat. No. 10,293,981, which is incorporated herein by reference in its entirety.

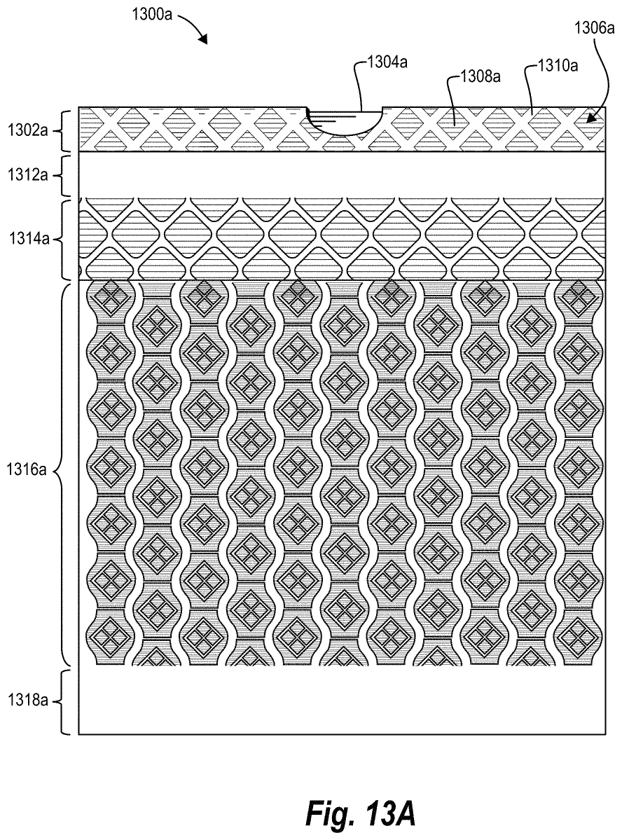

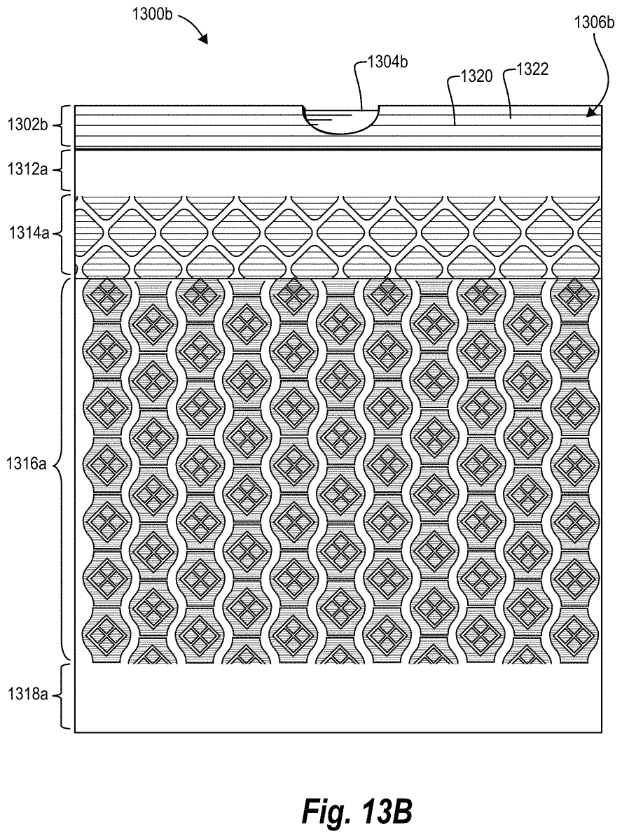

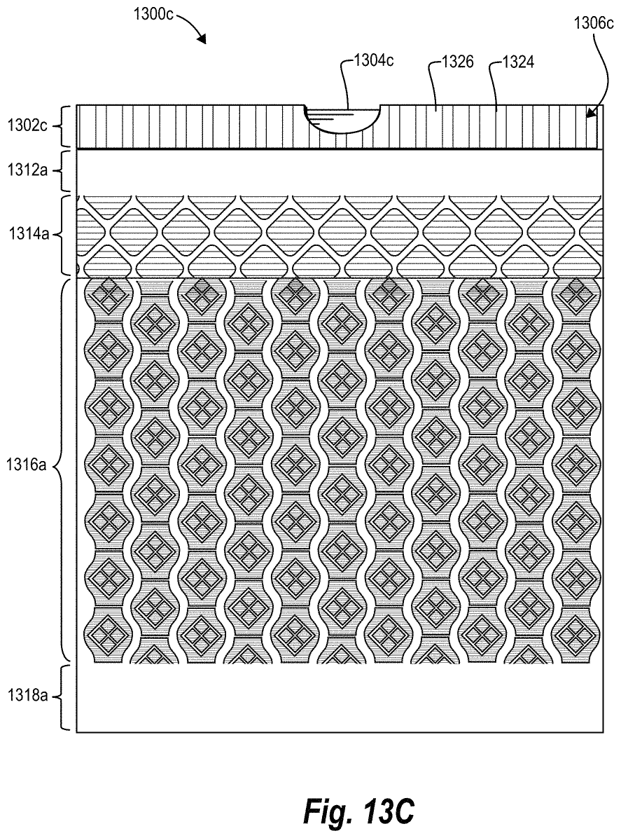

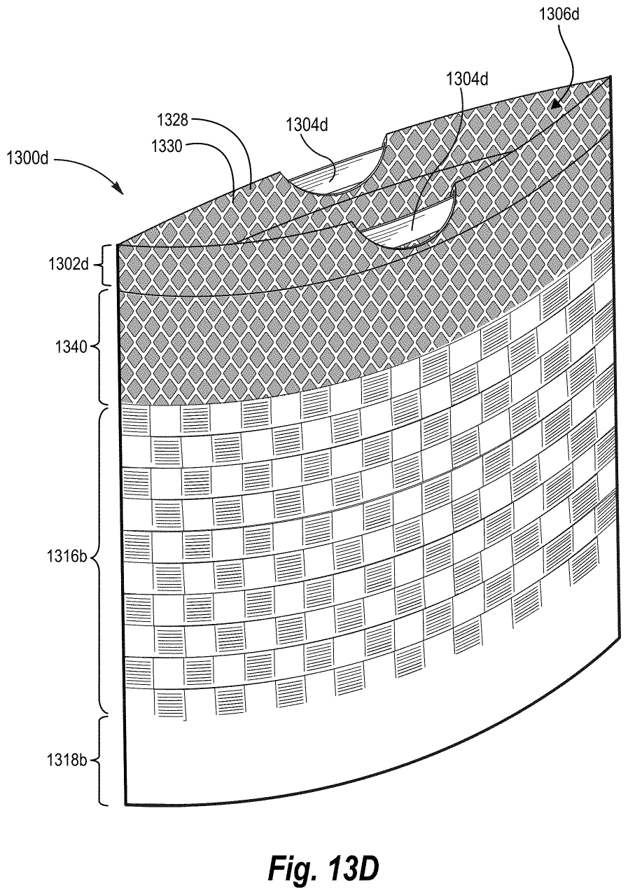

As discussed above, a thermoplastic bag can include a hem portion and a drawtape within the hem portion. The drawtape can include a plurality of ribs (e.g., raised rib-like elements formed from a SELF'ing process) and a plurality of web areas. The ribs can provide increased elasticity for the drawtape and further reduce the force needed to pull the drawtape from the hem portion by reducing the friction created between the drawtape and the hem portion. In some implementations, a thermoplastic bag further includes a hem portion having a deformation pattern, which can reduce the surface area of the hem portion that contacts the ribbed drawtape thereby further reducing friction and drag. FIGS. 13A-13D each illustrate an implementation of a thermoplastic bag having both a ribbed drawtape and a hem with a deformation pattern according to one or more embodiments of the present disclosure.

For example, FIG. 13A illustrates a thermoplastic bag 1300a with a drawtape 1304a having a plurality of ribs in accordance with one or more embodiments described above. The thermoplastic bag 1300a also includes a hem portion 1302a with a deformation pattern 1306a formed by SELF'ing. In particular, the hem portion 1302a can include a pattern of deformations including at least one of raised rib-like elements in a strainable network or alternating thicker ribs and thinner stretched webs. For example, as shown in FIG. 13A, the pattern includes 1) raised rib-like elements 1308a that provide visible expansion upon stress (e.g., the diamonds and lines), and 2) land or web areas 1310a. FIG. 13A further illustrates a plurality of raised rib-like elements 1308a comprise a repeating pattern that spans across the entire hem portion 1302a. Furthermore, they are separated by web areas 1310a that together form a strainable network that provides an elastic characteristic to the hem portion 1302a.

The raised rib-like elements 1308a can have height that extends away from the web areas 1310a such that the plurality of ribs of the drawtape 1304a generally come into contact with the raised rib-like elements 1308a rather than the web areas 1310a such that the surface area of the hem portion 1302a (e.g., the inner layer of the hem portion) that comes into contact with the drawtape 1304a as the drawtape 1304a moves is reduced. By further reducing the mechanical engagement, the thermoplastic bag 1300a reduces the friction that is created between the hem portion 1302a and the drawtape 1304a as the drawtape 1304a moves. Thus, the thermoplastic bag 1300a requires even less force to pull the drawtape 1304a from the hem portion 1302a than a bag with a hem portion lacking deformations.

FIG. 13A also illustrates that the grab zone can comprise an upper grab zone 1312a that is un-patterned or deformed and a lower grab zone 1314a that includes a pattern of raised rib-like elements in a diamond pattern that form a strainable network. In particular, the diamond pattern of raised rib-like elements can be formed by SELFing rollers and provide the grab zone with an elastic like characteristic. FIG. 13A also illustrates that the second area 1316a includes raised rib-like elements in a strainable network or alternating thicker ribs and thinner stretched webs. As shown, the pattern of deformations in the second area 1316a is distinct from the pattern deformations in the lower grab zone 1314a. As shown, the second area 1316a includes a pattern of elements that includes diamonds and wavy lines. For example, the pattern of elements in the second area 1316a can be a SELF'ing. In particular, the pattern or raised rib-like elements in the second area 1316a includes a SELFing pattern of bulbous areas with nested diamonds. Wavy land areas separate the SELFing patterns. In some implementations, the wavy land areas may be bonds between the layers of the sidewalls as well in embodiments in which the sidewalls include multiple layers. More particularly, the second area 1316a includes a pattern as described in International

Patent Application No. PCT/US2018/058998 filed on May 16, 2019 and entitled “THERMOPLASTIC FILMS AND BAGS WITH COMPLEX STRETCH PATTERNS AND METHODS OF MAKING THE SAME,” hereby incorporated by reference in its entirety. The third or bottom region 1318a is a flat portion or undeformed portion.

In addition to raised-rib like elements created by SELF'ing, one or more implementations include hem portions with deformation patterns formed from ring rolling. For example, FIG. 13B illustrates a thermoplastic bag 1300b with a drawtape 1304b having a plurality of ribs in accordance with one or more embodiments described above. The thermoplastic bag 1300b also includes a hem portion 1302b with a deformation pattern 1306b formed by transverse direction (TD) ring rolling. As shown, the TD ring rolling can extend across the entire width of the hem portion 1302b. The deformation pattern 1306b can comprises alternating thicker ribs 1320 and thinner stretched webs 1322 as described in NON-CONTINUOUSLY LAMINATED MULTI-LAYERED BAGS of U.S. Pat. No. 8,888,365, filed on Oct. 14, 2011 (hereafter “Fraser”), the contents of which are expressly incorporated herein by reference.

The thicker ribs 1320 can have height that extends away from the web areas 1322 such that the plurality of ribs of the drawtape 1304b generally come into contact with the thicker ribs 1320 rather than the web areas 1322 such that the surface area of the hem portion 1302b (e.g., the inner layer of the hem portion) that comes into contact with the drawtape 1304b as the drawtape 1304b moves is reduced. By further reducing the mechanical engagement, the thermoplastic bag 1300b reduces the friction that is created between the hem portion 1302b and the drawtape 1304b as the drawtape 1304b moves. Thus, the thermoplastic bag 1300b requires even less force to pull the drawtape 1304b from the hem portion 1302b than a bag with a hem portion lacking deformations. Furthermore, as the thicker ribs 1320 extend in the same direction that the drawtape 1304b is pulled, the thicker ribs 1320 can help guide the drawtape 1304b as the drawtape is pulled through the hem portion 1302b.

Along related lines, FIG. 13C illustrates a thermoplastic bag 1300c with a drawtape 1304c having a plurality of ribs in accordance with one or more embodiments described above. The thermoplastic bag 1300c also includes a hem portion 1302c with a deformation pattern 1306c formed by machine direction (MD) ring rolling. The deformation pattern 1306c can comprises alternating thicker ribs 1324 and thinner stretched webs 1326 as described in NON-CONTINUOUSLY LAMINATED MULTI-LAYERED BAGS of U.S. Pat. No. 8,888,365, filed on Oct. 14, 2011 (hereafter “Fraser”), the contents of which are expressly incorporated herein by reference.

The thicker ribs 1324 can have height that extends away from the web areas 1326 such that the plurality of ribs of the drawtape 1304c generally come into contact with the thicker ribs 1324 rather than the web areas 1326 such that the surface area of the hem portion 1302c (e.g., the inner layer of the hem portion) that comes into contact with the drawtape 1304c as the drawtape 1304c moves is reduced. By further reducing the mechanical engagement, the thermoplastic bag 1300c reduces the friction that is created between the hem portion 1302c and the drawtape 1304c as the drawtape 1304c moves. Thus, the thermoplastic bag 1300c requires even less force to pull the drawtape 1304c from the hem portion 1302c than a bag with a hem portion lacking deformations.

In addition to the foregoing, in one or more implementations a hem portion comprises a deformation pattern of contact areas such as those described in International Patent Application No. PCT/US2020/024143 filed on Mar. 23, 2020 and entitled “MULTI-FILM THERMOPLASTIC STRUCTURES AND BAGS HAVING VISUALLY-DISTINCT CONTACT AREAS AND METHODS OF MAKING THE SAME,” hereby incorporated by reference in its entirety. For example, FIG. 13D illustrates a perspective view of a multi-layer thermoplastic bag 1300d with a deformation pattern 1306d of diamond-shaped contact areas 1330 conjoin the inner and outer film layers in the grab zone 1340 in addition to the hem channel 1302d. The contact areas 1330 include “peelable” bonds between the films of the multi-film thermoplastic bag 1300d. When forces are applied to the multi-film thermoplastic bag 1300d, the contact areas 1330 are configured to fail (e.g., allow the films of the multi-film thermoplastic bag 1300d to separate) prior to any failure of the films (e.g., ripping, tearing, puncturing). Moreover, when positioned in the grab zone 1340, the contact area 1330 give an added perception of strength and quality to the multi-film thermoplastic bag 1300d as the light bonding in the contact areas 1330 causes the films of the multi-film thermoplastic bag 1300d to feel thicker and more rigid.

Furthermore, the contact areas 1330 are slightly recessed compared to surrounding unbonded regions 1328 such that the plurality of ribs of the drawtape 1304d generally come into contact with the unbonded regions 1328 rather than the web areas contact areas 1330 such that the surface area of the hem channel 1302d (e.g., the inner layer of the hem portion) that comes into contact with the drawtape 1304d as the drawtape 1304d moves is reduced. By further reducing the mechanical engagement, the thermoplastic bag 1300d reduces the friction that is created between the hem channel 1302d and the drawtape 1304d as the drawtape 1304d moves. Thus, the thermoplastic bag 1300d requires even less force to pull the drawtape 1304d from the hem channel 1302d than a bag with a hem portion lacking deformations.

As shown in FIG. 13D, the multi-film thermoplastic bag 1300d includes a grab zone or first region 1340, a second region 1316b, and a third region 1318b. The grab zone 1340 covers a portion of the multi-film thermoplastic bag 1300d extending from the hem seal toward the bottom edge of the multi-film thermoplastic bag 1300d.

The third region 1318b of the multi-film thermoplastic bag 1300d is a flat portion of the multi-film thermoplastic bag 1300d. In one or more implementations, the second region 1316b includes SELF'ed or ring rolled patterns as described above. As shown by FIG. 13D, the checkboard pattern of deformations can comprise a repeating pattern of raised rib-like elements. In particular, the checkboard pattern of deformations can include a first plurality of rib-like elements arranged pattern as described in International Patent Application No. PCT/US2018/058998 filed on May 16, 2019 and entitled “THERMOPLASTIC FILMS AND BAGS WITH COMPLEX STRETCH PATTERNS AND METHODS OF MAKING THE SAME,” hereby incorporated by reference in its entirety. Portions of the raised rib-like elements of the outer layer can be in direct contact and have the appearance of the inner of the bag 1300d. In contrast to the deformation pattern 1306d of contact areas, however, the portions of deformations (e.g., raised rib-like element of a SELFing pattern or alternating thicker ribs and thinner stretched webs of a ring rolling pattern) stretch the film incrementally to create areas of varying gauge or thickness.

In one or more implementations, it is desirable to have more thermoplastic material in areas of the bag 1300d (e.g., in the grab zones) that are often susceptible to tears, rips, or other failures. For example, the grab zone 1340 lacks significant deformations and is otherwise less stretched relative to the second region 1316b. The pattern of contact areas in the grab zone 1340 provide the region with pleasing aesthetics and visual cues of strength and durability without substantially changing the gauge of the films in the grab zone 1340.

Thus, FIGS. 13A-13D illustrate the hem portions 1302a -1302d having ribs and web areas in different deformation patterns. Indeed, the hem portions 1302a -1302d can include a variety of different patterns. A pattern can be formed on a hem portion to provide a particular appearance of the hem portion and/or to provide specific properties to the hem portion, such as properties related to elasticity and the reduction of mechanical forces with the drawtapes therein. In some cases, a hem portion includes a deformation pattern that matches or complements the deformation pattern of the drawtape therein.

By including a deformation pattern of ribs and web areas on the hem portion as well as the corresponding drawtape, a thermoplastic bag further reduces the mechanical engagement as the drawtape moves within the hem portion. For example, the thermoplastic bag further reduces the surface area of the hem portion (e.g., the inner layer of the hem portion) that comes into contact with the drawtape as the drawtape moves. By further reducing the mechanical engagement, the thermoplastic bag reduces the friction that is created between the hem portion and the drawtape as the drawtape moves. Thus, the thermoplastic bag requires less force to pull the drawtape from the hem portion. As mentioned, in some cases, the deformation pattern formed on the hem portion is selected to match or complement the deformation pattern on the drawtape, such as by minimizing the surface areas of the hem portion and the drawtape that come into contact.

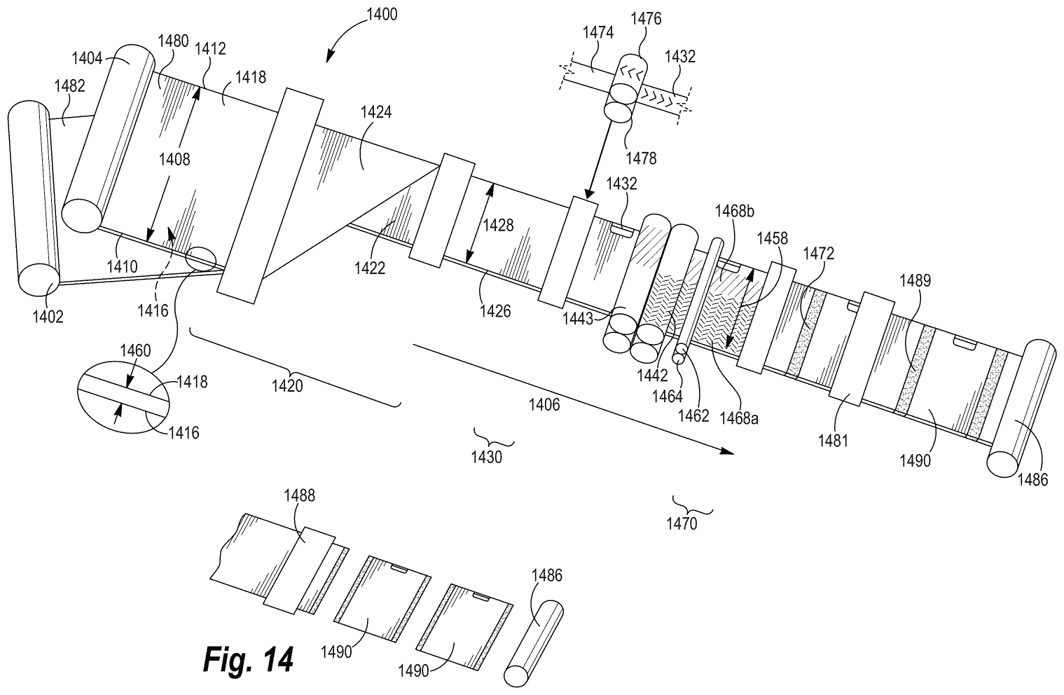

One or more implementations of the present invention can also include methods of forming thermoplastic bags having drawtapes that include deformation patterns, such as those described above. FIG. 14 and the accompanying description describe such methods according to one or more embodiments of the present disclosure. Of course, as a preliminary matter, one of ordinary skill in the art will recognize that the methods explained in detail herein can be modified.

For example, various acts of the method described can be omitted or expanded, additional acts can be included, and the order of the various acts of the method described can be altered as desired.

In particular, to produce thermoplastic bags having drawtapes that include the deformation patterns described above, continuous webs of thermoplastic material may be processed through a high-speed manufacturing environment such as that illustrated in FIG. 14. In the illustrated process 1400, production may begin by unwinding a first continuous web or film 1480 of a first thermoplastic material from a roll 1404 and advancing the web along a machine direction 1406. The unwound web 1480 may have a width 1408 that may be perpendicular to the machine direction 1406, as measured between a first edge 1410 and an opposite second edge 1412. The unwound web 1480 may have an initial average thickness 1460 measured between a first surface 1416 and a second surface 1418. In other manufacturing environments, the web 1480 may be provided in other forms or even extruded directly from a thermoplastic forming process.

The process 1400 further can optionally involve unwinding a second continuous web or film 1482 of a second thermoplastic material from a roll 1402 and advancing the web along a machine direction 1406. The second film 1482 can comprise, a width, and/or a thickness that is similar or the same as the first film 1480. In alternative one or more implementations, one or more of the width, and/or thickness of the second film 1482 can differ from that of the first film 1480.

To provide sidewalls of the finished bag, the film(s) 1480, 1482 may be folded into a first half 1422 and an opposing second half 1424 about the machine direction 1406 by a folding operation 1420. When so folded, the first edge 1410 may be moved adjacent to the second edge 1412 of the film(s) 1480, 1482. Accordingly, the width of the film(s) 1480, 1482 proceeding in the machine direction 1406 after the folding operation 1420 may be a width 1428 that may be half the initial width 1408. As may be appreciated, the portion mid-width of the unwound film(s) 1480, 1482 may become the outer edge 1426 of the folded web. In any event, the hems may be formed along the adjacent first and second edges 1410, 1412 and a drawtape 1432 may be inserted during a hem and drawtape operation 1430.

As shown in FIG. 14, prior to inserting the drawtape 1432 into the hems, the process 1400 includes creating a deformation pattern on the drawtape 1432. For example, as shown above, the process 1400 includes advancing drawtape material 1474 through a pair of SELF'ing intermeshing rollers 1476, 1478. In particular, as shown, the process 1400 includes advancing the drawtape material 1474 through the pair of SELF'ing intermeshing rollers 1476, 1478 lengthwise. As the drawtape material 1474 advances, the pair of SELF'ing intermeshing rollers 1476, 1478 create the drawtape 1432 having a deformation pattern of raised rib-like elements and web areas (though other deformation patterns of ribs and web areas can be formed). After forming the drawtape 1432 having the deformation pattern, the process 1400 includes inserting the drawtape 1432 into a hem during the hem and drawtape operation 1430.

By forming deformation patterns on drawtapes (e.g., the patterns described above), the process 1400 improves tape tracking due to the self-centering aspect of the symmetric ribbing pattern about the axis that extends across the drawtape lengthwise. Further, the process 1400 maintains an important aspect of laser detection to register non-oriented blank to seal.

To form deformations (e.g., phased deformations or non-phased deformations) in the film(s) 1480, 1482 and optionally bond multiple films together, the processing equipment includes pairs of SELF'ing intermeshing rollers (represented by the SELF'ing intermeshing rollers 1442, 1443) such as those described herein above. The folded film(s) 1480, 1482 may be advanced along the machine direction 1406 between the pairs of SELF'ing intermeshing rollers, which may be set into rotation to impart the resulting deformation patterns 1468a -1468b. To facilitate formation of the deformations, the each SELF'ing intermeshing roller of the pairs of SELF'ing intermeshing rollers may be forced or directed against each other by, for example, hydraulic actuators. The pressure at which the rollers are pressed together may be in a first range from 30 PSI (2.04 atm) to 100 PSI (6.8 atm), a second range from 60 PSI (4.08 atm) to 90 PSI (6.12 atm), and a third range from 75 PSI (5.10 atm) to 85 PSI (5.78 atm). In one or more implementations, the pressure may be about 80 PSI (5.44 atm). It should be noted that FIG. 14 illustrates a particular implementation of the process 1400 having multiple pairs of SELF'ing intermeshing rollers to impart a varying deformation pattern; however, other implementations include a single pair of SELF'ing intermeshing rollers to impart a uniform deformation pattern. Some instances of the process 1400 form thermoplastic bags without any SELF'ing intermeshing rollers that create deformation patterns on the thermoplastic bags themselves.

The processing equipment may include pinch rollers 1462, 1464 to accommodate the width 1428 of the film(s) 1480, 1482. To produce the finished bag, the processing equipment may further process the folded film(s) 1480, 1482. For example, to form the parallel side edges of the finished bag, the film(s) 1480, 1482 may proceed through a sealing operation 1470 in which heat seals 1472 may be formed between the folded edge 1426 and the adjacent edges 1410, 1412. The heat seals may fuse together the halves 1422, 1424 of the folded film(s) 1480, 1482. The heat seals 1472 may be spaced apart along the folded film(s) 1480, 1482 and in conjunction with the folded outer edge 1426 may define individual bags. The heat seals 1472 may be made with a heating device, such as, a heated knife. A perforating operation 1481 may form perforations 1489 in the heat seals 1472 with a perforating device, such as, a perforating knife so that individual bags 1490 may be separated from the film(s) 1480, 1482. In one or more implementations, the film(s) 1480, 1482 may be folded one or more times before the folded film(s) 1480, 1482 may be directed through the perforating operation. The film(s) 1480, 1482 embodying the bags 1490 may be wound into a roll 1486 for packaging and distribution. For example, the roll 1486 may be placed in a box or a bag for sale to a customer. As shown, the height 1458 of the bags 1490 is the same as, or substantially similar to, the width 1428 of the film(s) 1480, 1482.

In one or more implementations of the process, a cutting operation 1488 may replace the perforating operation 1481. The film(s) 1480, 1482 is directed through a cutting operation 1488 which cuts the film(s) 1480, 1482 at location into individual bags 1490 prior to winding onto a roll 1486 for packaging and distribution. For example, the roll 1486 may be placed in a box or bag for sale to a customer. The bags may be interleaved prior to winding into the roll 1486. In one or more implementations, the film(s) 1480, 1482 may be folded one or more times before the folded web is cut into individual bags. In one or more implementations, the bags 1490 may be positioned in a box or bag, and not onto the roll 1486.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. Moreover, any combination of the above-described elements in all possible variations thereof is encompassed by the invention unless otherwise indicated herein or otherwise clearly contradicted by context. All changes that come within the meaning and range of equivalency of the claims are to be embraced within their scope.

What is claimed is:

1. A thermoplastic bag, comprising:
a layer of thermoplastic material;
a hem portion formed from the layer of thermoplastic material along an edge of the layer of thermoplastic material; and
a drawtape within the hem portion, wherein the drawtape comprises:
a plurality of ribs that are mirrored across an axis corresponding to a length of the drawtape; and
a plurality of web areas, the plurality of web areas separating and connecting ribs of the plurality of ribs, wherein the plurality of web areas is out of plane with the ribs of the plurality of ribs so as to create recesses between adjacent ribs of the plurality of ribs.

2. The thermoplastic bag of claim 1, wherein the plurality of ribs comprises a plurality of raised rib-like elements that provide or increase an elasticity of the drawtape.

3. The thermoplastic bag of claim 1, wherein:
the drawtape comprises a top edge and a bottom edge, a width of the drawtape comprising a distance between the top edge and the bottom edge; and
a deformation pattern comprising the plurality of ribs and the plurality of web areas extends a distance between the top edge of the drawtape and the bottom edge of the drawtape that is less than the width of the drawtape.

4. The thermoplastic bag of claim 1, wherein the axis corresponding to the length of the drawtape is located at a center of the drawtape with respect to a width of the drawtape.

5. The thermoplastic bag of claim 4, wherein each rib from the plurality of ribs comprises:
a first component on a first side of the axis that extends from the axis across the drawtape in a non-parallel direction with respect to the width of the drawtape; and
a second component on a second side of the axis that connects to the first component at the axis and mirrors the non-parallel direction of the first component.

6. The thermoplastic bag of claim 1, wherein the hem portion comprises a deformation pattern that reduces contact between the hem portion and the drawtape.

7. The thermoplastic bag of claim 1,
further comprising a hem hole that exposes the drawtape from the hem portion,
wherein a deformation pattern comprising the plurality of ribs and the plurality of web areas is mirrored across an axis corresponding to a width of the drawtape at a portion of the drawtape exposed by the hem hole.

8. The thermoplastic bag of claim 7, wherein each rib from the plurality of ribs extends across the drawtape in a non-parallel direction with respect to the width of the drawtape, the non-parallel direction causing each rib to point toward the hem hole.

9. The thermoplastic bag of claim 1, wherein the plurality of ribs forms a pattern of ribs, the pattern of ribs comprising at least one of chasing arrows, w-shaped configurations, chasing crescents, chasing parabolas, chasing hyperbolas, or a combination of linear components and non-linear components.

10. The thermoplastic bag of claim 1, wherein:
a first set of ribs from the plurality of ribs are positioned above a center-line of the drawtape;
a second set of ribs from the plurality of ribs positioned below the center-line of the drawtape; and
the center-line of the drawtape is devoid of ribs.

11. A thermoplastic bag, comprising:
a first sidewall;
a second sidewall opposite the first sidewall and joined with the first sidewall along a first side edge, an opposite second side edge, and a bottom edge;
a hem portion along a top of at least one of the first sidewall or the second sidewall; and
a drawtape within the hem portion, wherein the drawtape comprises:
a plurality of ribs, wherein a rib length associated with each rib extends across the drawtape in a non-parallel direction with respect to a width of the drawtape; and
a plurality of web areas, the plurality of web areas separating and connecting ribs of the plurality of ribs, wherein the plurality of web areas is out of plane with the ribs of the plurality of ribs so as to create recesses between adjacent ribs of the plurality of ribs.

12. The thermoplastic bag of claim 11, wherein:
the width of the drawtape comprises a distance between a top edge of the drawtape and a bottom edge of the drawtape; and
the plurality of ribs comprises a plurality of raised rib-like elements that provide the drawtape with increased elasticity and extend a distance between the top edge and the bottom edge that is less than the width of the drawtape.

13. The thermoplastic bag of claim 11, wherein the plurality of ribs are mirrored across an axis corresponding to a length of the drawtape, the axis located at a center of the drawtape with respect to the width of the drawtape.

14. The thermoplastic bag of claim 11, further comprising a hem hole that exposes the drawtape from the hem portion, wherein:
a deformation pattern comprising the plurality of ribs and the plurality of web areas is mirrored across an axis corresponding to the width of the drawtape at a portion of the drawtape exposed by the hem hole; and
the non-parallel direction with respect to the width of the drawtape causes each rib from the plurality of ribs to point toward the hem hole.

15. The thermoplastic bag of claim 11, wherein the plurality of ribs comprises a plurality of rib heights.

16. The thermoplastic bag of claim 11, wherein the plurality of ribs comprises a plurality of non-linear components.

17. The thermoplastic bag of claim 16, wherein the plurality of ribs further comprises a plurality of linear components.

18. A method of manufacturing thermoplastic bags having low-friction, elastic drawtapes, comprising:
advancing a drawtape through a pair of intermeshing rollers to generate:
a plurality of ribs that are mirrored across an axis corresponding to a length of the drawtape, wherein a rib length associated with each rib extends across the drawtape in a non-parallel direction with respect to a width of the drawtape; and
a plurality of web areas, the plurality of web areas separating and connecting ribs of the plurality of ribs, wherein the plurality of web areas is out of plane with the ribs of the plurality of ribs so as to create recesses between adjacent ribs of the plurality of ribs;
inserting the drawtape into a hem portion of a thermoplastic film; and
forming the thermoplastic film into a bag.

19. The method of claim 18, wherein advancing the drawtape through the pair of intermeshing rollers comprises advancing the drawtape through intermeshing rollers having a single rotation that spans the width of the bag.

20. The method of claim 18, wherein advancing the drawtape through the pair of intermeshing rollers to generate the plurality of ribs comprises advancing the drawtape through the pair of intermeshing rollers to generate:
a first set of ribs that point towards a hem hole in the hem portion of the thermoplastic film in a first direction; and
a second set of ribs that point towards the hem hole in the hem portion of the thermoplastic film in a second direction, the first set of ribs and the second set of ribs forming a deformation pattern that is symmetrical about the hem hole.
